(19) United States
(12) Patent Application Publication
(10) Pub. No.: US 2024/0297972 A1
(43) Pub. Date: Sep. 5, 2024

(54) SYSTEM AND COMPONENT ARCHITECTURES FOR AR AND VR DEVICES

(71) Applicant: Meta Platforms Technologies, LLC, Menlo Park, CA (US)

(72) Inventors: Hanqiao Zhang, Sammamish, WA (US); Patrick Codd, Carnation, WA (US); Dongmin Yang, San Jose, CA (US); Yi Zhou, San Jose, CA (US); Yizhi Xiong, Foster City, CA (US); Fei Liu, Los Altos, CA (US); Abhishek Dhanda, San Ramon, CA (US); Michael Okincha, San Jose, CA (US); Linsen Bie, San Francisco, CA (US); Honghong Peng, Los Altos, CA (US); Zhaochun Yu, Wilmette, IL (US); Lidu Huang, Danville, CA (US); Shaomin Xiong, Newark, CA (US); Gabriel Molina, Sunnyvale, CA (US); Pablo Castillo Canales, San Ramon, CA (US); Peng Chen, Fremont, CA (US); Danni Luo, Sunnyvale, CA (US); Eddie Alex Azuma, Pleasanton, CA (US); Kong Boon Yeap, Campbell, CA (US); Dana Jensen, Redwood City, CA (US); Cameron O'Neill, New York, NY (US); Guangwu Duan, Cupertino, CA (US); Raffael Engleitner, Morris Twp, NJ (US); David Xu, Lafayette, CA (US); Yibo Liu, Richmond Hill, CA (US); Ankur Verma, San Jose, CA (US); Lei Zhao, Pittsburgh, PA (US); Yuecheng Li, Pittsburgh, PA (US); Dawei Wang, Pittsburgh, PA (US)

(21) Appl. No.: 18/515,793

(22) Filed: Nov. 21, 2023

Related U.S. Application Data
(60) Provisional application No. 63/488,027, filed on Mar. 2, 2023.
(60) Provisional application No. 63/488,708, filed on Mar. 6, 2023.
(60) Provisional application No. 63/488,566, filed on Mar. 6, 2023.
(60) Provisional application No. 63/491,808, filed on Mar. 23, 2023.

(51) Int. Cl. H04N 13/239; H04N 13/156

(52) U.S. Cl. CPC H04N 13/239; H04N 13/156

(57) ABSTRACT

An augmented reality apparatus includes a plurality of transmission lines, plural signal-generating circuits, at least one additional transmission line, at least one signal-processing circuit, a multiplexer having a plurality of inputs and at least one output, a plurality of matching networks, and an additional matching network coupling the additional transmission line to the output of the multiplexer. Example AR/VR devices include a camera configured to receive light from the external environment of the device and to provide a camera signal. The camera may include a surface variable lens including a support layer, an optical layer, a membrane layer, and an actuator. A computer-implemented method for anatomical electromyography test design includes identifying a wearable device having a frame including a plurality of electrodes, and calibrating the plurality of electrodes. In augmented reality and virtual reality systems, DNN accelerators may be based on various technologies to improve computing speed and energy efficiency.

### CROSS-REFERENCE TO RELATED APPLICATIONS

This application claims the benefit of priority under 35 U.S.C. § 119(e) of U.S. Provisional Application No. 63/488,027, filed Mar. 2, 2023, U.S. Provisional Application No. 63/488,708, filed Mar. 6, 2023, U.S. Provisional Application No. 63/488,566, filed Mar. 6, 2023, and U.S. Provisional Application No. 63/491,808, filed Mar. 23, 2023, the contents of which are incorporated herein by reference in their entirety.

### BRIEF DESCRIPTION OF THE DRAWINGS AND APPENDICES

The accompanying drawings and appendices illustrate a number of exemplary embodiments and are a part of the specification. Together with the following description, these drawings and appendices demonstrate and explain various principles of the present disclosure.

FIG. 1 is a block diagram of an example multiplexing circuit with matching networks according to embodiments of this disclosure.

FIG. 2 is a block diagram of an example system having a multiplexing circuit with matching networks according to embodiments of this disclosure.

FIG. 3 is an illustration of improved return loss at Nyquist frequencies provided by embodiments of this disclosure.

FIG. 4 is an illustration of Time-Domain-Reflectometry (TDR) Impedance of embodiments of this disclosure.

FIG. 5 is an illustration of an example spiral transmission-line matching network according to embodiments of this disclosure.

FIG. 6 is an illustration of example eye diagrams.

FIG. 7 is an illustration of additional example eye diagrams.

FIG. 8 is an illustration of example eye-diagram statistics.

FIG. 9 is an illustration of exemplary augmented-reality glasses that may be used in connection with embodiments of this disclosure.

FIG. 10 is an illustration of an exemplary virtual-reality headset that may be used in connection with embodiments of this disclosure.

FIG. 11 is an illustration of exemplary haptic devices that may be used in connection with embodiments of this disclosure.

FIG. 12 is an illustration of an exemplary virtual-reality environment according to embodiments of this disclosure.

FIG. 13 is an illustration of an exemplary augmented-reality environment according to embodiments of this disclosure.

FIG. 14 an illustration of an exemplary system that incorporates an eye-tracking subsystem capable of tracking a user's eye(s).

FIG. 15 is a more detailed illustration of various aspects of the eye-tracking subsystem illustrated in FIG. 14.

FIGS. 16A and 16B are illustrations of an exemplary human-machine interface configured to be worn around a user's lower arm or wrist.

FIGS. 17A and 17B are illustrations of an exemplary schematic diagram with internal components of a wearable system.

FIGS. 18A and 18B illustrate an example optical assembly including a surface profile variable lens that may be used for auto-focus applications.

FIG. 18C shows an optical assembly including a variable lens.

FIGS. 19A and 19B show example optical assemblies including a surface profile variable lens.

FIGS. 20A and 20B illustrate use of an actuator to change the surface tilt angle of a variable lens.

FIG. 21 shows examples of electrically controlling a surface tilt angle of a variable lens.

FIG. 22 illustrates two perspective views of an exemplary wearable device.

FIG. 23 illustrates a cross sectional view of an exemplary wearable device.

FIG. 24 illustrates a side view of an exemplary electrode plunger.

FIG. 25 illustrates a side view of an exemplary electrode plunger communicatively coupled to a dynamic profile.

FIG. 26 illustrates a side view of an exemplary wearable device configured with complementary parts.

FIG. 27 illustrates a perspective view of an exemplary validation fixture.

FIG. 28 illustrates a perspective view of a fixed load exemplary validation fixture.

FIG. 29 illustrates a cross sectional view of a fixed load exemplary validation fixture.

FIG. 30 illustrates a perspective view of an exemplary fixed load validation fixture configured with complementary parts.

FIG. 31 depicts the structure of a ReRAM cell and exemplary approaches to compute MVM and bit-wise NOR.

FIG. 32 shows an example computer graphics pipeline.

FIG. 33 is a schematic representation of a ReARVR architecture.

FIG. 34 depicts computing rasterization in a crossbar.

FIG. 35 is an example of texture sampling.

FIG. 36 depicts an exemplary pixel codec avatar.

FIG. 37 is a plot showing normalized execution time of ReARVR over baseline.

FIG. 38 is a plot showing normalized energy consumption of ReARVR over baseline.

Throughout the drawings, identical reference characters and descriptions may indicate similar, but not necessarily identical, elements. While the exemplary embodiments described herein are susceptible to various modifications and alternative forms, specific embodiments have been shown by way of example in the drawings and appendices and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

### Matching Networks for Multiplexers and Demultiplexers

A multiplexer (or mux) switch may include a combinational logic circuit designed to switch one of several input lines through to a single common output line by the application of a control signal. Multiplexers may be used in AR prototyping and production devices. For example, multiplexers may enable multiple cameras to send high-speed CPHY signals over a common transmission line at different times or speeds and/or may reduce pin count on application processors (APs). One example of such application may include left and right simultaneous localization and mapping (SLAM) cameras being connected to an AP through a 2:1 multiplexer. In some examples, multiplexers may be digital circuits made from high-speed logic gates or analog circuits using transistors, where the through impedance can be extremely low compared to the characteristic impedance of high-speed links (e.g., 15 ohm vs. 50 ohm). As a result, multiplexers may introduce significant discontinuities to the high-speed links and/or cause poor link signal integrity performance. This in turn may cause camera malfunction and/or systems being forced to run at a lower frame rate, aka lower data rate.

The present disclosure is generally directed to matching networks that mitigate the impedance mismatch problem inherent to conventional multiplexers. In some examples, spiral transmission line matching networks may be implemented at the input and output of a multiplexer. In some examples, the inductance loading from a disclosed matching network may compensate low multiplexer impedance by more than 30%. In some examples, return loss may be improved from −10 dB to lower than −15 dB in certain interesting frequency ranges. In some examples, e.g., at SLAM frame/data rates, the disclosed matching networks may cause high-speed signal eye diagram openings to be improved by 16 ps. In some examples, e.g., at higher frame/data rates, the disclosed matching networks may open a closed eye diagram by improving eye height and eye width by 9 mV and 11ps, respectively. In some examples, the disclosed matching networks may be designed with board real estate in mind. For example, a spiral shape may not take more space on a board. In some examples, the disclosed matching networks may not add extra cost to PCB manufacturing. In some examples, the disclosed designs may improve high-speed signal integrity and/or robustness at current camera frame/data rates and may unlock high frame rate in the next generation AR products.

Features from any of the embodiments described herein may be used in combination with one another in accordance with the general principles described herein. These and other embodiments, features, and advantages will be more fully understood upon reading the following detailed description in conjunction with the accompanying drawings and claims.

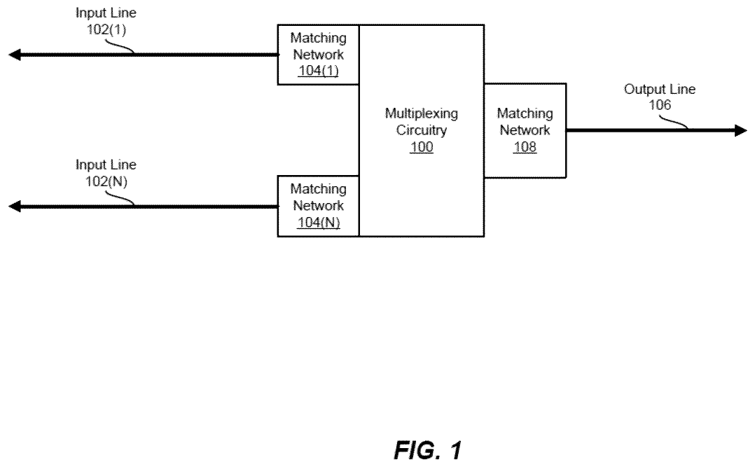

FIG. 1 illustrates example multiplexing circuitry 100 with matching networks. In some examples, multiplexing circuitry 100 may represent or include a multiplexer (or mux) switch. In some examples, multiplexing circuitry 100 may represent or include a combinational logic circuit designed to switch one of several input lines through to a single common output line by the application of a control signal. As shown, multiplexing circuitry 100 may represent or include a multiplexer, mux, or data selector, that selects between signals on input lines 102(1)-(N) and forwards the selected signal to output line 106. In some embodiments, input lines 102(1)-(N) and/or output line 106 may represent transmission lines and/or high-speed data links.

In some examples, one or more of input lines 102(1)-(N) and/or output line 106 may have impedances (e.g., characteristic impedances) that do not match an impedance of multiplexing circuitry 100. In such examples, matching networks 104(1)-(N) and/or matching network 108 may be used to mitigate the impedance mismatch problem. For example, matching networks 104(1)-(N) may be configured to match the input impedances of the inputs of multiplexing circuitry 100 to the impedances of input lines 102(1)-(N), respectively. Similarly, matching network 108 may be configured to match the output impedance of the output of multiplexing circuitry 100 to the impedance of output line 106.

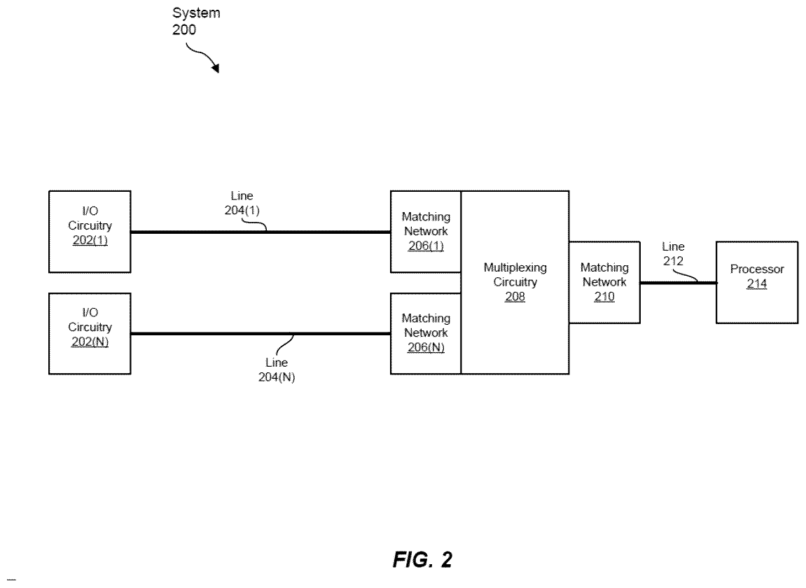

FIG. 2 illustrates an example system 200 having a multiplexing circuit with matching networks. In this example, system 200 includes I/O circuitries 202(1)-(N) (e.g., cameras, microphones, and/or other type or forms of sensors) that send signals to a processor 214 through multiplexing circuitry 208. As shown, each of I/O circuitries 202(1)-(N) may be connected to an input of multiplexing circuitry 208 via one of lines 204(1)-(N) and one of matching networks 206(1)-(N), and processor 214 may be connected to an output of multiplexing circuitry 208 via line 212 and matching network 210.

In some examples, multiplexing circuitry 208 may represent or include a multiplexer (or mux) switch. In some examples, multiplexing circuitry 208 may represent or include a combinational logic circuit designed to switch one of several input lines through to a single common output line by the application of a control signal. As shown, multiplexing circuitry 208 may represent or include a multiplexer, mux, or data selector, that selects between signals generated by I/O circuitries 202(1)-(N) on input lines 204(1)-(N) and forwards the selected signal to processor 214 via output line 212. In some embodiments, input lines 204(1)-(N) and/or output line 212 may represent transmission lines.

In some examples, one or more of input lines 204(1)-(N) and/or output line 212 may have impedances (e.g., characteristic impedances) that do not match an impedance of multiplexing circuitry 208. In such examples, matching networks 206(1)-(N) and/or matching network 210 may be used to mitigate the impedance mismatch problem. For example, matching networks 206(1)-(N) may be configured to match the input impedances of the inputs of multiplexing circuitry 208 to the impedances of input lines 204(1)-(N), respectively. Similarly, matching network 210 may be configured to match the output impedance of the output of multiplexing circuitry 208 to the impedance of output line 212.

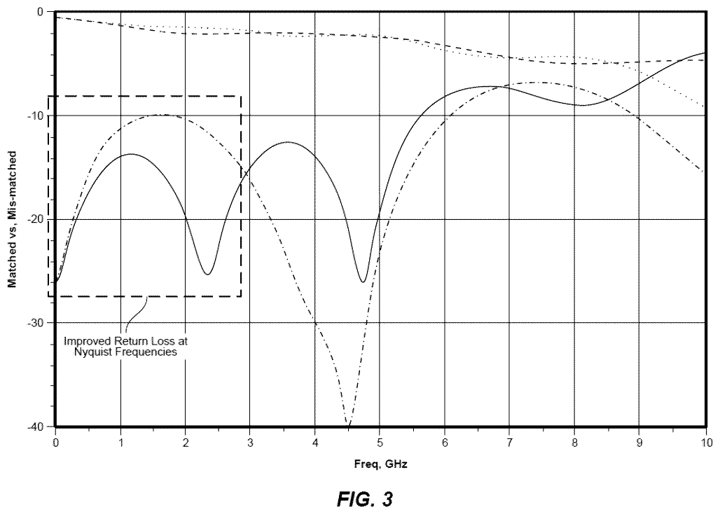

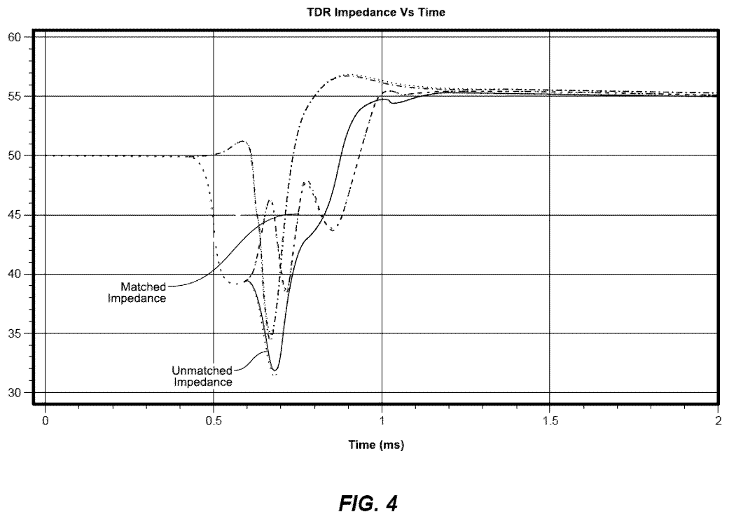

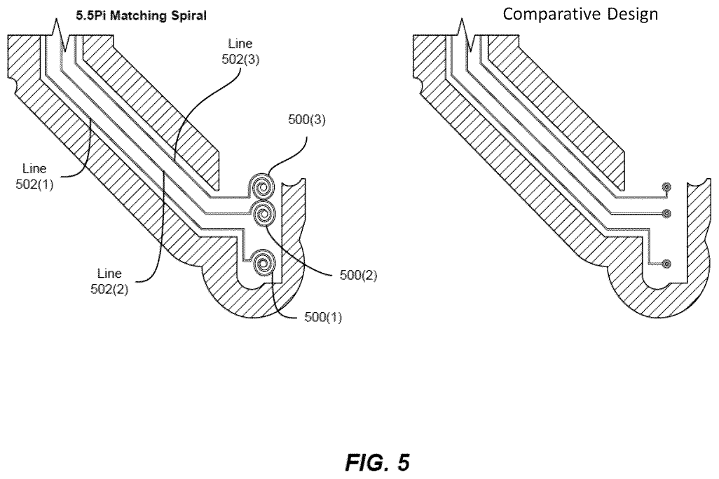

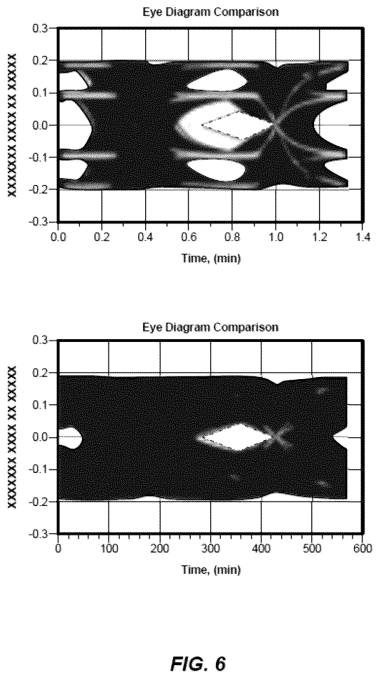

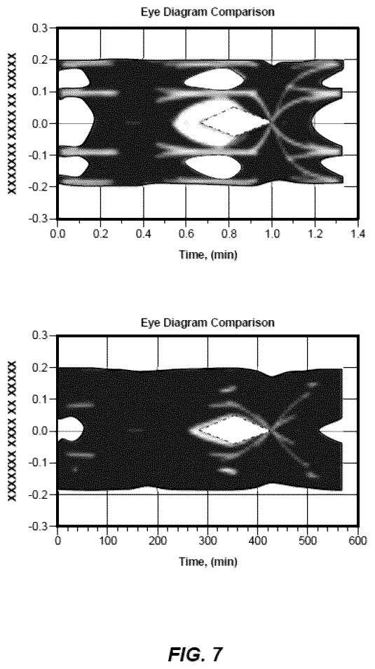

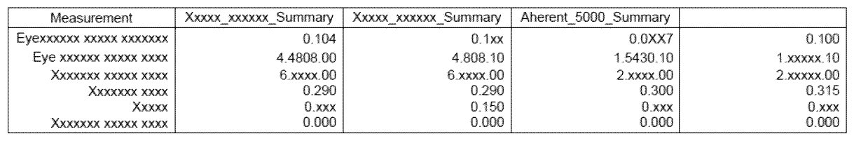

FIG. 5 illustrates example spiral transmission-line matching networks 500 and associated transmission lines 502. In some examples, spiral transmission line matching networks 500 may have a 5.5 PI configuration and 25 um line width and be implemented at the input and output of a mux (e.g., multiplexing circuitry 100 or 200). In some examples, an added inductance of ˜0.6 nH may compensate for a low impedance of the mux. At SLAM POR speed, signal eye diagrams may be improved by 16 ps. At higher frame/data rates, the matching network may open the closed eye diagram by 9 mV and 11 ps for eye height and eye width. Examples of a structure of the matching network, impedance, return loss, insertion loss, and eye diagram improvements are shown in FIGS. 3, 4, and 6-8.

Embodiments of the present disclosure may include or be implemented in-conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

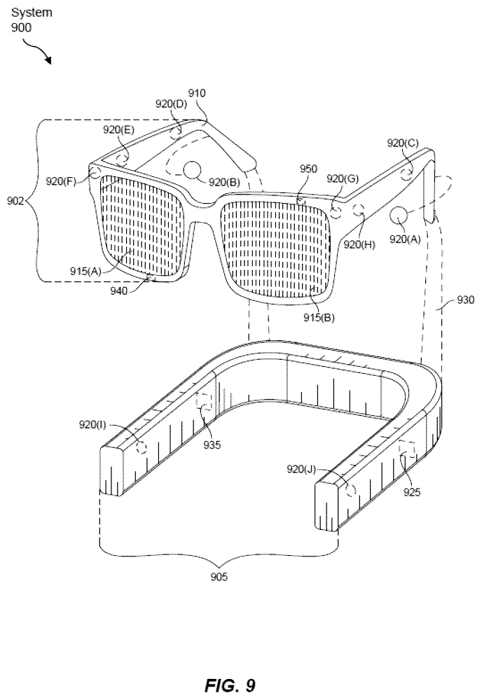

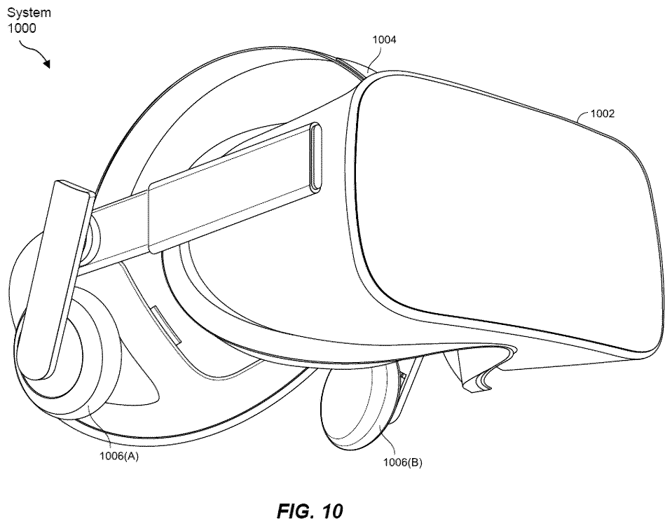

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 900 in FIG. 9) or that visually immerses a user in an artificial reality (such as, e.g., virtual-reality system 1000 in FIG. 10). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 9, augmented-reality system 900 may include an eyewear device 902 with a frame 910 configured to hold a left display device 915(A) and a right display device 915(B) in front of a user's eyes. Display devices 915(A) and 915(B) may act together or independently to present an image or series of images to a user. While augmented-reality system 900 includes two displays, embodiments of this disclosure may be implemented in augmented-reality systems with a single NED or more than two NEDs.

In some embodiments, augmented-reality system 900 may include one or more sensors, such as sensor 940. Sensor 940 may generate measurement signals in response to motion of augmented-reality system 900 and may be located on substantially any portion of frame 910. Sensor 940 may represent one or more of a variety of different sensing mechanisms, such as a position sensor, an inertial measurement unit (IMU), a depth camera assembly, a structured light emitter and/or detector, or any combination thereof. In some embodiments, augmented-reality system 900 may or may not include sensor 940 or may include more than one sensor. In embodiments in which sensor 940 includes an IMU, the IMU may generate calibration data based on measurement signals from sensor 940. Examples of sensor 940 may include, without limitation, accelerometers, gyroscopes, magnetometers, other suitable types of sensors that detect motion, sensors used for error correction of the IMU, or some combination thereof.

In some examples, augmented-reality system 900 may also include a microphone array with a plurality of acoustic transducers 920(A)-920(J), referred to collectively as acoustic transducers 920. Acoustic transducers 920 may represent transducers that detect air pressure variations induced by sound waves. Each acoustic transducer 920 may be configured to detect sound and convert the detected sound into an electronic format (e.g., an analog or digital format). The microphone array in FIG. 9 may include, for example, ten acoustic transducers: 920(A) and 920(B), which may be designed to be placed inside a corresponding ear of the user, acoustic transducers 920(C), 920(D), 920(E), 920(F), 920(G), and 920(H), which may be positioned at various locations on frame 910, and/or acoustic transducers 920(I) and 920(J), which may be positioned on a corresponding neckband 905.

In some embodiments, one or more of acoustic transducers 920(A)-(J) may be used as output transducers (e.g., speakers). For example, acoustic transducers 920(A) and/or 920(B) may be earbuds or any other suitable type of headphone or speaker.

The configuration of acoustic transducers 920 of the microphone array may vary. While augmented-reality system 900 is shown in FIG. 9 as having ten acoustic transducers 920, the number of acoustic transducers 920 may be greater or less than ten. In some embodiments, using higher numbers of acoustic transducers 920 may increase the amount of audio information collected and/or the sensitivity and accuracy of the audio information. In contrast, using a lower number of acoustic transducers 920 may decrease the computing power required by an associated controller 950 to process the collected audio information. In addition, the position of each acoustic transducer 920 of the microphone array may vary. For example, the position of an acoustic transducer 920 may include a defined position on the user, a defined coordinate on frame 910, an orientation associated with each acoustic transducer 920, or some combination thereof.

Acoustic transducers 920(A) and 920(B) may be positioned on different parts of the user's ear, such as behind the pinna, behind the tragus, and/or within the auricle or fossa. Or, there may be additional acoustic transducers 920 on or surrounding the ear in addition to acoustic transducers 920 inside the ear canal. Having an acoustic transducer 920 positioned next to an ear canal of a user may enable the microphone array to collect information on how sounds arrive at the ear canal. By positioning at least two of acoustic transducers 920 on either side of a user's head (e.g., as binaural microphones), augmented-reality device 900 may simulate binaural hearing and capture a 3D stereo sound field around about a user's head. In some embodiments, acoustic transducers 920(A) and 920(B) may be connected to augmented-reality system 900 via a wired connection 930, and in other embodiments acoustic transducers 920(A) and 920(B) may be connected to augmented-reality system 900 via a wireless connection (e.g., a BLUETOOTH connection). In still other embodiments, acoustic transducers 920(A) and 920(B) may not be used at all in conjunction with augmented-reality system 900.

Acoustic transducers 920 on frame 910 may be positioned in a variety of different ways, including along the length of the temples, across the bridge, above or below display devices 915(A) and 915(B), or some combination thereof. Acoustic transducers 920 may also be oriented such that the microphone array is able to detect sounds in a wide range of directions surrounding the user wearing the augmented-reality system 900. In some embodiments, an optimization process may be performed during manufacturing of augmented-reality system 900 to determine relative positioning of each acoustic transducer 920 in the microphone array.

In some examples, augmented-reality system 900 may include or be connected to an external device (e.g., a paired device), such as neckband 905. Neckband 905 generally represents any type or form of paired device. Thus, the following discussion of neckband 905 may also apply to various other paired devices, such as charging cases, smart watches, smart phones, wrist bands, other wearable devices, hand-held controllers, tablet computers, laptop computers, other external compute devices, etc.

As shown, neckband 905 may be coupled to eyewear device 902 via one or more connectors. The connectors may be wired or wireless and may include electrical and/or non-electrical (e.g., structural) components. In some cases, eyewear device 902 and neckband 905 may operate independently without any wired or wireless connection between them. While FIG. 9 illustrates the components of eyewear device 902 and neckband 905 in example locations on eyewear device 902 and neckband 905, the components may be located elsewhere and/or distributed differently on eyewear device 902 and/or neckband 905. In some embodiments, the components of eyewear device 902 and neckband 905 may be located on one or more additional peripheral devices paired with eyewear device 902, neckband 905, or some combination thereof.

Pairing external devices, such as neckband 905, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 900 may be provided by a paired device or shared between a paired device and an eyewear device, thus reducing the weight, heat profile, and form factor of the eyewear device overall while still retaining desired functionality. For example, neckband 905 may allow components that would otherwise be included on an eyewear device to be included in neckband 905 since users may tolerate a heavier weight load on their shoulders than they would tolerate on their heads. Neckband 905 may also have a larger surface area over which to diffuse and disperse heat to the ambient environment. Thus, neckband 905 may allow for greater battery and computation capacity than might otherwise have been possible on a stand-alone eyewear device. Since weight carried in neckband 905 may be less invasive to a user than weight carried in eyewear device 902, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 905 may be communicatively coupled with eyewear device 902 and/or to other devices. These other devices may provide certain functions (e.g., tracking, localizing, depth mapping, processing, storage, etc.) to augmented-reality system 900. In the embodiment of FIG. 9, neckband 905 may include two acoustic transducers (e.g., 920(I) and 920(J)) that are part of the microphone array (or potentially form their own microphone subarray). Neckband 905 may also include a controller 925 and a power source 935.

Acoustic transducers 920(I) and 920(J) of neckband 905 may be configured to detect sound and convert the detected sound into an electronic format (analog or digital). In the embodiment of FIG. 9, acoustic transducers 920(I) and 920(J) may be positioned on neckband 905, thereby increasing the distance between the neckband acoustic transducers 920(I) and 920(J) and other acoustic transducers 920 positioned on eyewear device 902. In some cases, increasing the distance between acoustic transducers 920 of the microphone array may improve the accuracy of beamforming performed via the microphone array. For example, if a sound is detected by acoustic transducers 920(C) and 920(D) and the distance between acoustic transducers 920(C) and 920(D) is greater than, e.g., the distance between acoustic transducers 920(D) and 920(E), the determined source location of the detected sound may be more accurate than if the sound had been detected by acoustic transducers 920(D) and 920(E).

Controller 925 of neckband 905 may process information generated by the sensors on neckband 905 and/or augmented-reality system 900. For example, controller 925 may process information from the microphone array that describes sounds detected by the microphone array. For each detected sound, controller 925 may perform a direction-of-arrival (DOA) estimation to estimate a direction from which the detected sound arrived at the microphone array. As the microphone array detects sounds, controller 925 may populate an audio data set with the information. In embodiments in which augmented-reality system 900 includes an inertial measurement unit, controller 925 may compute all inertial and spatial calculations from the IMU located on eyewear device 902. A connector may convey information between augmented-reality system 900 and neckband 905 and between augmented-reality system 900 and controller 925. The information may be in the form of optical data, electrical data, wireless data, or any other transmittable data form. Moving the processing of information generated by augmented-reality system 900 to neckband 905 may reduce weight and heat in eyewear device 902, making it more comfortable to the user.

Power source 935 in neckband 905 may provide power to eyewear device 902 and/or to neckband 905. Power source 935 may include, without limitation, lithium ion batteries, lithium-polymer batteries, primary lithium batteries, alkaline batteries, or any other form of power storage. In some cases, power source 935 may be a wired power source. Including power source 935 on neckband 905 instead of on eyewear device 902 may help better distribute the weight and heat generated by power source 935.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1000 in FIG. 10, that mostly or completely covers a user's field of view. Virtual-reality system 1000 may include a front rigid body 1002 and a band 1004 shaped to fit around a user's head. Virtual-reality system 1000 may also include output audio transducers 1006(A) and 1006(B). Furthermore, while not shown in FIG. 10, front rigid body 1002 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 900 and/or virtual-reality system 1000 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented reality system 900 and/or virtual-reality system 1000 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 900 and/or virtual-reality system 1000 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

Some augmented-reality systems may map a user's and/or device's environment using techniques referred to as “simultaneous location and mapping” (SLAM). SLAM mapping and location identifying techniques may involve a variety of hardware and software tools that can create or update a map of an environment while simultaneously keeping track of a user's location within the mapped environment. SLAM may use many different types of sensors to create a map and determine a user's position within the map.

SLAM techniques may, for example, implement optical sensors to determine a user's location. Radios including WiFi, BLUETOOTH, global positioning system (GPS), cellular or other communication devices may be also used to determine a user's location relative to a radio transceiver or group of transceivers (e.g., a WiFi router or group of GPS satellites). Acoustic sensors such as microphone arrays or 2D or 3D sonar sensors may also be used to determine a user's location within an environment. Augmented-reality and virtual-reality devices (such as systems 900 and 1000 of FIGS. 9 and 10, respectively) may incorporate any or all of these types of sensors to perform SLAM operations such as creating and continually updating maps of the user's current environment. In at least some of the embodiments described herein, SLAM data generated by these sensors may be referred to as “environmental data” and may indicate a user's current environment. This data may be stored in a local or remote data store (e.g., a cloud data store) and may be provided to a user's AR/VR device on demand.

When the user is wearing an augmented reality headset or virtual-reality headset in a given environment, the user may be interacting with other users or other electronic devices that serve as audio sources. In some cases, it may be desirable to determine where the audio sources are located relative to the user and then present the audio sources to the user as if they were coming from the location of the audio source. The process of determining where the audio sources are located relative to the user may be referred to as “localization,” and the process of rendering playback of the audio source signal to appear as if it is coming from a specific direction may be referred to as “spatialization.”

Localizing an audio source may be performed in a variety of different ways. In some cases, an augmented-reality or virtual-reality headset may initiate a DOA analysis to determine the location of a sound source. The DOA analysis may include analyzing the intensity, spectra, and/or arrival time of each sound at the artificial-reality device to determine the direction from which the sounds originated. The DOA analysis may include any suitable algorithm for analyzing the surrounding acoustic environment in which the artificial-reality device is located.

For example, the DOA analysis may be designed to receive input signals from a microphone and apply digital signal processing algorithms to the input signals to estimate the direction of arrival. These algorithms may include, for example, delay and sum algorithms where the input signal is sampled, and the resulting weighted and delayed versions of the sampled signal are averaged together to determine a direction of arrival. A least mean squared (LMS) algorithm may also be implemented to create an adaptive filter. This adaptive filter may then be used to identify differences in signal intensity, for example, or differences in time of arrival. These differences may then be used to estimate the direction of arrival. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct-path audio signal. Those bins having a portion of the direct-path signal may then be analyzed to identify the angle at which a microphone array received the direct-path audio signal. The determined angle may then be used to identify the direction of arrival for the received input signal. Other algorithms not listed above may also be used alone or in combination with the above algorithms to determine DOA.

In some embodiments, different users may perceive the source of a sound as coming from slightly different locations. This may be the result of each user having a unique head-related transfer function (HRTF), which may be dictated by a user's anatomy including ear canal length and the positioning of the ear drum. The artificial-reality device may provide an alignment and orientation guide, which the user may follow to customize the sound signal presented to the user based on their unique HRTF. In some embodiments, an artificial-reality device may implement one or more microphones to listen to sounds within the user's environment. The augmented-reality or virtual-reality headset may use a variety of different array transfer functions (e.g., any of the DOA algorithms identified above) to estimate the direction of arrival for the sounds. Once the direction of arrival has been determined, the artificial-reality device may play back sounds to the user according to the user's unique HRTF. Accordingly, the DOA estimation generated using the array transfer function (ATF) may be used to determine the direction from which the sounds are to be played from. The playback sounds may be further refined based on how that specific user hears sounds according to the HRTF.

In addition to or as an alternative to performing a DOA estimation, an artificial-reality device may perform localization based on information received from other types of sensors. These sensors may include cameras, IR sensors, heat sensors, motion sensors, GPS receivers, or in some cases, sensors that detect a user's eye movements. For example, as noted above, an artificial-reality device may include an eye tracker or gaze detector that determines where the user is looking. Often, the user's eyes will look at the source of the sound, if only briefly. Such clues provided by the user's eyes may further aid in determining the location of a sound source. Other sensors such as cameras, heat sensors, and IR sensors may also indicate the location of a user, the location of an electronic device, or the location of another sound source. Any or all of the above methods may be used individually or in combination to determine the location of a sound source and may further be used to update the location of a sound source over time.

Some embodiments may implement the determined DOA to generate a more customized output audio signal for the user. For instance, an “acoustic transfer function” may characterize or define how a sound is received from a given location. More specifically, an acoustic transfer function may define the relationship between parameters of a sound at its source location and the parameters by which the sound signal is detected (e.g., detected by a microphone array or detected by a user's ear). An artificial-reality device may include one or more acoustic sensors that detect sounds within range of the device. A controller of the artificial-reality device may estimate a DOA for the detected sounds (using, e.g., any of the methods identified above) and, based on the parameters of the detected sounds, may generate an acoustic transfer function that is specific to the location of the device. This customized acoustic transfer function may thus be used to generate a spatialized output audio signal where the sound is perceived as coming from a specific location.

Indeed, once the location of the sound source or sources is known, the artificial-reality device may re-render (i.e., spatialize) the sound signals to sound as if coming from the direction of that sound source. The artificial-reality device may apply filters or other digital signal processing that alter the intensity, spectra, or arrival time of the sound signal. The digital signal processing may be applied in such a way that the sound signal is perceived as originating from the determined location. The artificial-reality device may amplify or subdue certain frequencies or change the time that the signal arrives at each ear. In some cases, the artificial-reality device may create an acoustic transfer function that is specific to the location of the device and the detected direction of arrival of the sound signal. In some embodiments, the artificial-reality device may re-render the source signal in a stereo device or multi-speaker device (e.g., a surround sound device). In such cases, separate and distinct audio signals may be sent to each speaker. Each of these audio signals may be altered according to the user's HRTF and according to measurements of the user's location and the location of the sound source to sound as if they are coming from the determined location of the sound source. Accordingly, in this manner, the artificial-reality device (or speakers associated with the device) may re-render an audio signal to sound as if originating from a specific location.

As noted, artificial-reality systems 900 and 1000 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

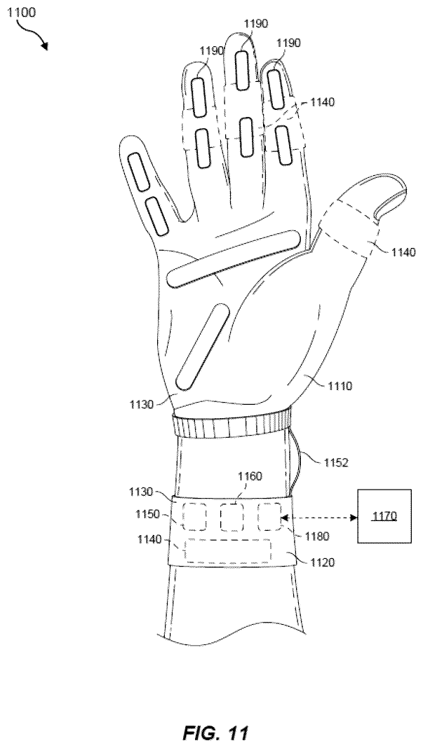

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 11 illustrates a vibrotactile system 1100 in the form of a wearable glove (haptic device 1110) and wristband (haptic device 1120). Haptic device 1110 and haptic device 1120 are shown as examples of wearable devices that include a flexible, wearable textile material 1130 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 1140 may be positioned at least partially within one or more corresponding pockets formed in textile material 1130 of vibrotactile system 1100. Vibrotactile devices 1140 may be positioned in locations to provide a vibrating sensation (e.g., haptic feedback) to a user of vibrotactile system 1100. For example, vibrotactile devices 1140 may be positioned against the user's finger(s), thumb, or wrist, as shown in FIG. 11. Vibrotactile devices 1140 may, in some examples, be sufficiently flexible to conform to or bend with the user's corresponding body part(s).

A power source 1150 (e.g., a battery) for applying a voltage to the vibrotactile devices 1140 for activation thereof may be electrically coupled to vibrotactile devices 1140, such as via conductive wiring 1152. In some examples, each of vibrotactile devices 1140 may be independently electrically coupled to power source 1150 for individual activation. In some embodiments, a processor 1160 may be operatively coupled to power source 1150 and configured (e.g., programmed) to control activation of vibrotactile devices 1140.

Vibrotactile system 1100 may be implemented in a variety of ways. In some examples, vibrotactile system 1100 may be a standalone system with integral subsystems and components for operation independent of other devices and systems. As another example, vibrotactile system 1100 may be configured for interaction with another device or system 1170. For example, vibrotactile system 1100 may, in some examples, include a communications interface 1180 for receiving and/or sending signals to the other device or system 1170. The other device or system 1170 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 1180 may enable communications between vibrotactile system 1100 and the other device or system 1170 via a wireless (e.g., Wi-Fi, BLUETOOTH, cellular, radio, etc.) link or a wired link. If present, communications interface 1180 may be in communication with processor 1160, such as to provide a signal to processor 1160 to activate or deactivate one or more of the vibrotactile devices 1140.

Vibrotactile system 1100 may optionally include other subsystems and components, such as touch-sensitive pads 1190, pressure sensors, motion sensors, position sensors, lighting elements, and/or user interface elements (e.g., an on/off button, a vibration control element, etc.). During use, vibrotactile devices 1140 may be configured to be activated for a variety of different reasons, such as in response to the user's interaction with user interface elements, a signal from the motion or position sensors, a signal from the touch-sensitive pads 1190, a signal from the pressure sensors, a signal from the other device or system 1170, etc.

Although power source 1150, processor 1160, and communications interface 1180 are illustrated in FIG. 11 as being positioned in haptic device 1120, the present disclosure is not so limited. For example, one or more of power source 1150, processor 1160, or communications interface 1180 may be positioned within haptic device 1110 or within another wearable textile.

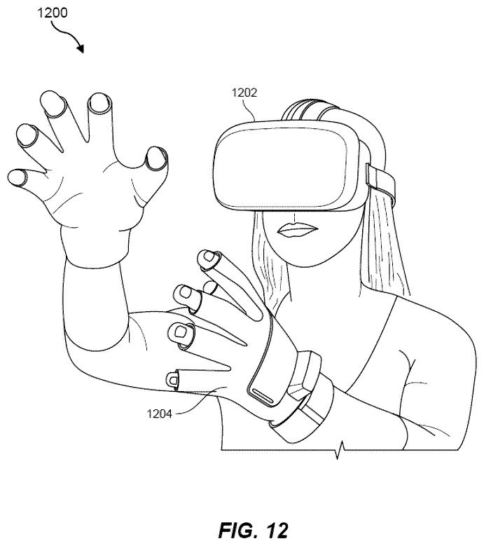

Haptic wearables, such as those shown in and described in connection with FIG. 11, may be implemented in a variety of types of artificial-reality systems and environments. FIG. 12 shows an example artificial-reality environment 1200 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1202 generally represents any type or form of virtual-reality system, such as virtual-reality system 1000 in FIG. 10. Haptic device 1204 generally represents any type or form of wearable device, worn by a user of an artificial-reality system, that provides haptic feedback to the user to give the user the perception that he or she is physically engaging with a virtual object. In some embodiments, haptic device 1204 may provide haptic feedback by applying vibration, motion, and/or force to the user. For example, haptic device 1204 may limit or augment a user's movement. To give a specific example, haptic device 1204 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 1204 to send action requests to a console. Examples of action requests include, without limitation, requests to start an application and/or end the application and/or requests to perform a particular action within the application.

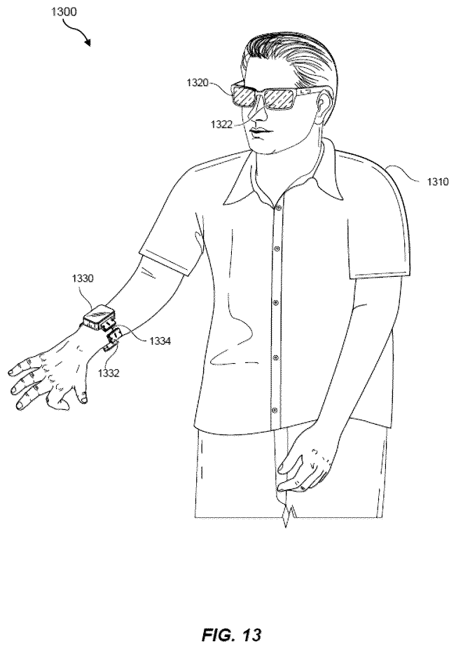

While haptic interfaces may be used with virtual-reality systems, as shown in FIG. 12, haptic interfaces may also be used with augmented-reality systems, as shown in FIG. 13.

FIG. 13 is a perspective view of a user 1310 interacting with an augmented-reality system 1300. In this example, user 1310 may wear a pair of augmented-reality glasses 1320 that may have one or more displays 1322 and that are paired with a haptic device 1330. In this example, haptic device 1330 may be a wristband that includes a plurality of band elements 1332 and a tensioning mechanism 1334 that connects band elements 1332 to one another.

One or more of band elements 1332 may include any type or form of actuator suitable for providing haptic feedback. For example, one or more of band elements 1332 may be configured to provide one or more of various types of cutaneous feedback, including vibration, force, traction, texture, and/or temperature. To provide such feedback, band elements 1332 may include one or more of various types of actuators. In one example, each of band elements 1332 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 1110, 1120, 1204, and 1330 may include any suitable number and/or type of haptic transducer, sensor, and/or feedback mechanism. For example, haptic devices 1110, 1120, 1204, and 1330 may include one or more mechanical transducers, piezoelectric transducers, and/or fluidic transducers. Haptic devices 1110, 1120, 1204, and 1330 may also include various combinations of different types and forms of transducers that work together or independently to enhance a user's artificial-reality experience. In one example, each of band elements 1332 of haptic device 1330 may include a vibrotactor (e.g., a vibrotactile actuator) configured to vibrate in unison or independently to provide one or more of various types of haptic sensations to a user.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

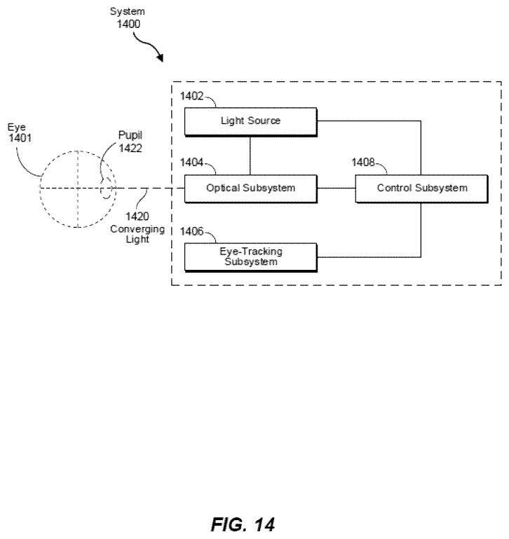

FIG. 14 is an illustration of an exemplary system 1400 that incorporates an eye-tracking subsystem capable of tracking a user's eye(s). As depicted in FIG. 14, system 1400 may include a light source 1402, an optical subsystem 1404, an eye-tracking subsystem 1406, and/or a control subsystem 1408. In some examples, light source 1402 may generate light for an image (e.g., to be presented to an eye 1401 of the viewer). Light source 1402 may represent any of a variety of suitable devices. For example, light source 1402 can include a two-dimensional projector (e.g., a LCOS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 1404 may receive the light generated by light source 1402 and generate, based on the received light, converging light 1420 that includes the image. In some examples, optical subsystem 1404 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 1420. Further, various mechanical couplings may serve to maintain the relative spacing and/or the orientation of the optical components in any suitable combination.

In one embodiment, eye-tracking subsystem 1406 may generate tracking information indicating a gaze angle of an eye 1401 of the viewer. In this embodiment, control subsystem 1408 may control aspects of optical subsystem 1404 (e.g., the angle of incidence of converging light 1420) based at least in part on this tracking information. Additionally, in some examples, control subsystem 1408 may store and utilize historical tracking information (e.g., a history of the tracking information over a given duration, such as the previous second or fraction thereof) to anticipate the gaze angle of eye 1401 (e.g., an angle between the visual axis and the anatomical axis of eye 1401). In some embodiments, eye-tracking subsystem 1406 may detect radiation emanating from some portion of eye 1401 (e.g., the cornea, the iris, the pupil, or the like) to determine the current gaze angle of eye 1401. In other examples, eye-tracking subsystem 1406 may employ a wavefront sensor to track the current location of the pupil.

Any number of techniques can be used to track eye 1401. Some techniques may involve illuminating eye 1401 with infrared light and measuring reflections with at least one optical sensor that is tuned to be sensitive to the infrared light. Information about how the infrared light is reflected from eye 1401 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 1406 may be digitized (i.e., converted to an electronic signal). Further, the sensor may transmit a digital representation of this electronic signal to one or more processors (for example, processors associated with a device including eye-tracking subsystem 1406). Eye-tracking subsystem 1406 may include any of a variety of sensors in a variety of different configurations. For example, eye-tracking subsystem 1406 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 1406 to track the movement of eye 1401. In another example, these processors may track the movements of eye 1401 by executing algorithms represented by computer-executable instructions stored on non- transitory memory. In some examples, on-chip logic (e.g., an application-specific integrated circuit or ASIC) may be used to perform at least portions of such algorithms. As noted, eye-tracking subsystem 1406 may be programmed to use an output of the sensor(s) to track movement of eye 1401. In some embodiments, eye-tracking subsystem 1406 may analyze the digital representation generated by the sensors to extract eye rotation information from changes in reflections. In one embodiment, eye-tracking subsystem 1406 may use corneal reflections or glints (also known as Purkinje images) and/or the center of the eye's pupil 1422 as features to track over time.

In some embodiments, eye-tracking subsystem 1406 may use the center of the eye's pupil 1422 and infrared or near-infrared, non-collimated light to create corneal reflections. In these embodiments, eye-tracking subsystem 1406 may use the vector between the center of the eye's pupil 1422 and the corneal reflections to compute the gaze direction of eye 1401. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 1406 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 1401 may act as a retroreflector as the light reflects off the retina, thereby creating a bright pupil effect similar to a red-eye effect in photography. If the illumination source is offset from the optical path, then the eye's pupil 1422 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 1408 may control light source 1402 and/or optical subsystem 1404 to reduce optical aberrations (e.g., chromatic aberrations and/or monochromatic aberrations) of the image that may be caused by or influenced by eye 1401. In some examples, as mentioned above, control subsystem 1408 may use the tracking information from eye-tracking subsystem 1406 to perform such control. For example, in controlling light source 1402, control subsystem 1408 may alter the light generated by light source 1402 (e.g., by way of image rendering) to modify (e.g., pre-distort) the image so that the aberration of the image caused by eye 1401 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

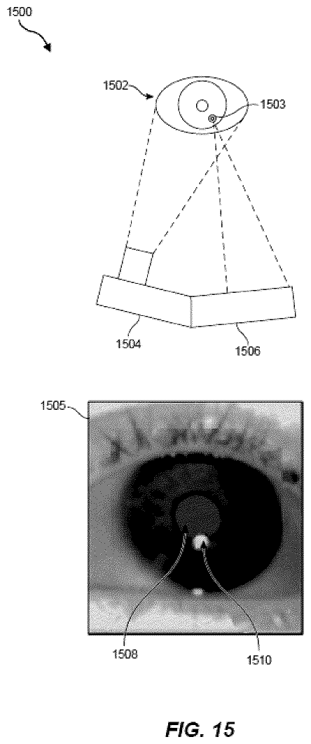

FIG. 15 is a more detailed illustration of various aspects of the eye-tracking subsystem illustrated in FIG. 14. As shown in this figure, an eye-tracking subsystem 1500 may include at least one source 1504 and at least one sensor 1506. Source 1504 generally represents any type or form of element capable of emitting radiation. In one example, source 1504 may generate visible, infrared, and/or near-infrared radiation. In some examples, source 1504 may radiate non-collimated infrared and/or near-infrared portions of the electromagnetic spectrum towards an eye 1502 of a user. Source 1504 may utilize a variety of sampling rates and speeds. For example, the disclosed systems may use sources with higher sampling rates in order to capture fixational eye movements of a user's eye 1502 and/or to correctly measure saccade dynamics of the user's eye 1502. As noted above, any type or form of eye-tracking technique may be used to track the user's eye 1502, including optical-based eye-tracking techniques, ultrasound-based eye-tracking techniques, etc.

Sensor 1506 generally represents any type or form of element capable of detecting radiation, such as radiation reflected off the user's eye 1502. Examples of sensor 1506 include, without limitation, a charge coupled device (CCD), a photodiode array, a complementary metal-oxide-semiconductor (CMOS) based sensor device, and/or the like. In one example, sensor 1506 may represent a sensor having predetermined parameters, including, but not limited to, a dynamic resolution range, linearity, and/or other characteristic selected and/or designed specifically for eye tracking.

As detailed above, eye-tracking subsystem 1500 may generate one or more glints. As detailed above, a glint 1503 may represent reflections of radiation (e.g., infrared radiation from an infrared source, such as source 1504) from the structure of the user's eye. In various embodiments, glint 1503 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 15 shows an example image 1505 captured by an eye-tracking subsystem, such as eye-tracking subsystem 1500. In this example, image 1505 may include both the user's pupil 1508 and a glint 1510 near the same. In some examples, pupil 1508 and/or glint 1510 may be identified using an artificial-intelligence-based algorithm, such as a computer-vision-based algorithm. In one embodiment, image 1505 may represent a single frame in a series of frames that may be analyzed continuously in order to track the eye 1502 of the user. Further, pupil 1508 and/or glint 1510 may be tracked over a period of time to determine a user's gaze.

In one example, eye-tracking subsystem 1500 may be configured to identify and measure the inter-pupillary distance (IPD) of a user. In some embodiments, eye-tracking subsystem 1500 may measure and/or calculate the IPD of the user while the user is wearing the artificial reality system. In these embodiments, eye-tracking subsystem 1500 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to adjust the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 1400 and/or eye-tracking subsystem 1500 may be incorporated into augmented-reality system 900 in FIG. 9 and/or virtual-reality system 1000 in FIG. 10 to enable these systems to perform various eye-tracking tasks (including one or more of the eye-tracking operations described herein).

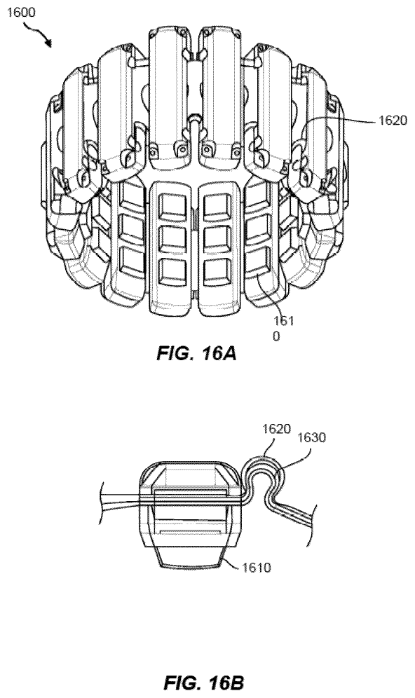

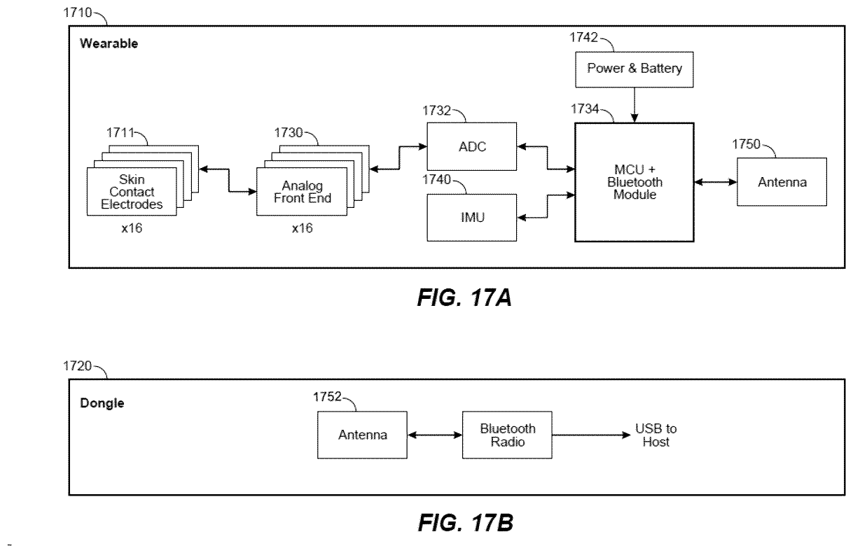

FIG. 16A illustrates an exemplary human-machine interface (also referred to herein as an EMG control interface) configured to be worn around a user's lower arm or wrist as a wearable system 1600. In this example, wearable system 1600 may include sixteen neuromuscular sensors 1610 (e.g., EMG sensors) arranged circumferentially around an elastic band 1620 with an interior surface 1630 configured to contact a user's skin. However, any suitable number of neuromuscular sensors may be used. The number and arrangement of neuromuscular sensors may depend on the particular application for which the wearable device is used. For example, a wearable armband or wristband can be used to generate control information for controlling an augmented reality system, a robot, controlling a vehicle, scrolling through text, controlling a virtual avatar, or any other suitable control task. As shown, the sensors may be coupled together using flexible electronics incorporated into the wireless device. FIG. 16B illustrates a cross-sectional view through one of the sensors of the wearable device shown in FIG. 16A. In some embodiments, the output of one or more of the sensing components can be optionally processed using hardware signal processing circuitry (e.g., to perform amplification, filtering, and/or rectification). In other embodiments, at least some signal processing of the output of the sensing components can be performed in software. Thus, signal processing of signals sampled by the sensors can be performed in hardware, software, or by any suitable combination of hardware and software, as aspects of the technology described herein are not limited in this respect. A non-limiting example of a signal processing chain used to process recorded data from sensors 1610 is discussed in more detail below with reference to FIGS. 17A and 17B.

FIGS. 17A and 17B illustrate an exemplary schematic diagram with internal components of a wearable system with EMG sensors. As shown, the wearable system may include a wearable portion 1710 (FIG. 17A) and a dongle portion 1720 (FIG. 17B) in communication with the wearable portion 1710 (e.g., via BLUETOOTH or another suitable wireless communication technology). As shown in FIG. 17A, the wearable portion 1710 may include skin contact electrodes 1711, examples of which are described in connection with FIGS. 16A and 16B. The output of the skin contact electrodes 1711 may be provided to analog front end 1730, which may be configured to perform analog processing (e.g., amplification, noise reduction, filtering, etc.) on the recorded signals. The processed analog signals may then be provided to analog-to-digital converter 1732, which may convert the analog signals to digital signals that can be processed by one or more computer processors. An example of a computer processor that may be used in accordance with some embodiments is microcontroller (MCU) 1734, illustrated in FIG. 17A. As shown, MCU 1734 may also include inputs from other sensors (e.g., IMU sensor 1740), and power and battery module 1742. The output of the processing performed by MCU 1734 may be provided to antenna 1750 for transmission to dongle portion 1720 shown in FIG. 17B.

Dongle portion 1720 may include antenna 1752, which may be configured to communicate with antenna 1750 included as part of wearable portion 1710. Communication between antennas 1750 and 1752 may occur using any suitable wireless technology and protocol, non-limiting examples of which include radiofrequency signaling and BLUETOOTH. As shown, the signals received by antenna 1752 of dongle portion 1720 may be provided to a host computer for further processing, display, and/or for effecting control of a particular physical or virtual object or objects.

Although the examples provided with reference to FIGS. 16A-16B and FIGS. 17A-17B are discussed in the context of interfaces with EMG sensors, the techniques described herein for reducing electromagnetic interference can also be implemented in wearable interfaces with other types of sensors including, but not limited to, mechanomyography (MMG) sensors, sonomyography (SMG) sensors, and electrical impedance tomography (EIT) sensors. The techniques described herein for reducing electromagnetic interference can also be implemented in wearable interfaces that communicate with computer hosts through wires and cables (e.g., USB cables, optical fiber cables, etc.).

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a lens that comprises or includes polycarbonate include embodiments where a lens consists essentially of polycarbonate and embodiments where a lens consists of polycarbonate.

### AR/VR Device Camera Including Surface Profile Variable Lens

The present disclosure is directed to apparatus and methods relating to AR/VR devices which may include at least one of an augmented reality (AR), virtual reality (VR) and/or a mixed reality (MR) device. An example AR/VR device may include a display configured to provide image elements, such as virtual, augmented or mixed reality elements, to the user when the user wears the device. An optical configuration located between the display and the eyebox may be used to form the image of the display at a location termed the eyebox. In some examples, such as augmented reality (AR), the AR image elements may be combined with light or electronic images obtained from an external environment, such as the physical surroundings of the device. In this context, the term AR may include mixed reality (MR).

In some examples, an AR/VR device may include one or more cameras to obtain external images relating to the device environment. It is generally desirable to minimize the weight of a head-mounted device and hence fixed-focus cameras may be used to provide arguably sufficient quality images, though with a limited depth of field such as between 40 cm-50 cm and infinity. A fixed-focus camera may require trading off the camera image quality for near and distant objects as it may not be possible to obtain the highest quality images for both near and distant objects using a fixed-focus camera. Further, high or low temperatures may reduce image quality for a fixed-focus camera. Image quality may be unacceptable outside of the fixed depth of field, for example, for objects in the environment located at a distance less than 40 cm-50 cm from the device.

Example approaches to varying the focal length of a lens include the VCM (voice coil motor) based auto-focus camera. However, these cameras may not meet the size miniaturization and low power consumption requirements of an AR/VR device. The moving parts of a VCM camera may also causes reliability issue and generates particles that may degrade image quality and device reliability. A VCM may be used to move the lens group or the sensor to achieve the desired auto-focus. However, disadvantages of a VCM, in particular for an VR/AR device or smart watch camera, include at least one of: high power consumption, a relatively large footprint in X/Y dimensions, and/or generation of electromagnetic field interference, includes moving parts that leads to the generation of particles.

These and other disadvantages may be avoided in an AR/VR device that includes one or more surface profile variable lenses, which may also be referred to as variable lenses for conciseness. Variable lenses may also be referred to as adjustable lenses, as one or more optical parameters may be adjusted. Optical parameters may include focal length, optical power, prism, and/or other parameters.

In some examples, an VR/AR device camera may include a lens assembly including at least one variable lens. A variable lens may be referred to as a varifocal lens (e.g., a lens having an adjustable focal length). A camera may include one or more variable lenses allowing the camera to perform operations, such as one or more of image capture, zoom, auto-focus, and/or optical image stabilization. Surface profile variable lenses may be adjusted, for example, by applying a mechanical force and/or electrical signals to at least one surface of the surface profile variable lens, as discussed in more detail below.

Examples include variable lenses for use in cameras used in example AR/VR devices (in particular, AR devices) that allow auto-focused external images of the environment to be obtained by the device. In some examples, images obtained at a number of different focus locations may be combined to obtain a wide depth of field. Image quality may be relatively high (e.g., compared to a fixed-focus camera) due to image always in best focus, particularly for nearby objects at a distance less than 40 cm from the device. Lenses can also be designed with lower f-number for better low light performance (e.g., by allowing an increased lens aperture and/or available reduced focal length).

A variable lens may include a polymer layer located between a membrane and a hard substrate or a pair of substrate layers, such as glass plates. A piezoelectric film located on the outer surface of one of the layers may allow the layer to be tilted or otherwise deformed (e.g., curved) to adjust the optical properties of the lens assembly. A lens assembly (e.g., for a camera) may include one or more fixed lenses and one or more variable lenses. Applications also include zoom adjustment and optical stabilization using one or more variable lenses.

Example AR/VR devices may include one or more cameras. Example cameras may include smart glass POV (point of view) cameras, wrist selfie cameras, MR (mixed reality) pass-through RGB cameras, VR device cameras, and/or eye-tracking cameras. In some examples, a camera may be located separate from and/or remote from the AR/VR device. An AR/VR device may communicate with a camera (e.g., including a variable lens) using a wired or wireless communication link. In some examples, a remote camera may be used to provide a different viewpoint, for example, the point of view of another character within a real and/or virtual environment.

In some examples, a surface profile variable lens may provide one or more of the following advantages: allowing an ultra-compact element, a fast response time (e.g., approximately 2 ms or less), ultra-low power consumption (e.g., less than 10 mW, such as approximately 6 mW), a large focus range (e.g., approximately 10 cm to infinity), a constant field of view (e.g., no zoom bump), reduced or eliminated electromagnetic interference issues, reduced gravity impact in different postures (e.g., orientation-independent lens performance), and/or no moving parts (e.g., eliminating concerns regarding wear, lifetime, or particle generation).

Example aspects may include at least one or more of the following features: fast (e.g., effectively instantaneous refocus), extended DOF (eDOF) where all elements within the environment may be brought in focus by fusing multiple frames obtained with different focal lengths, or shallow DOF (sDOF) which provides a bokeh effect that may be desirable, for example, in portrait mode, offline refocus, depth measurement, optical zoom, and/or optical image stabilization.

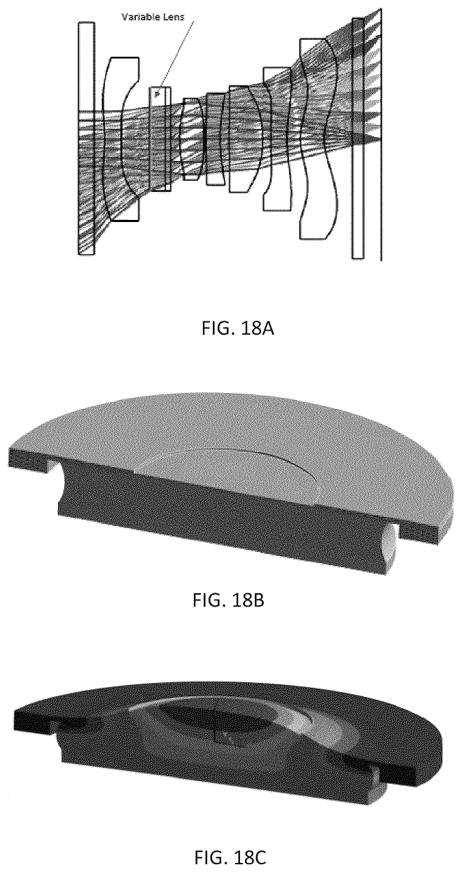

FIGS. 18A and 18B illustrate an example optical assembly including a surface profile variable lens that may be used for auto-focus applications. FIG. 18C shows an optical assembly including a variable lens.

FIG. 18B shows an example variable lens in more detail. The variable lens may include an optical layer located between first and second layers. The first (lower) layer may be referred to as a support layer and may have a generally disk-shaped form. The second (upper) layer may have a generally ring-shaped form having inner and outer radii. The second layer may have a central aperture defined by the inner radius. An actuator layer may be located around the periphery of the second layer, for example, where the second layer may extend outwards beyond the optical layer. The actuator may be configured to urge the second layer towards or away from the first layer based on the desired optical properties.

FIG. 18C shows that a force applied to the upper layer may induce a deformation of the variable lens. For example, applying a downwards force at the edges (as shown in this example) may cause the central area to extend outwardly upwards, for example, through an aperture in the ring-shaped layer. This may increase the optical power of an example variable lens and hence increase the optical power of a lens assembly including the variable lens. In some examples, a ring-shaped layer may be an actuator layer configured to apply forces to the periphery of a membrane layer. In some examples, the optical layer may further include a membrane layer (such as flexible membrane, e.g., an elastic membrane) and the ring-shaped layer may be, include, or support an actuator layer. in some examples, the optical layer may be enclosed in a membrane, such as a flexible membrane.

An example variable lens may include an optical layer located between first and second layers. The first and/or second layer may include a solid layer, such as glass layer, and may be referred to as first and second substrate layers. In some examples, the variable lens may include a support layer (e.g., a glass layer), an optical layer (e.g., a polymer layer), and a membrane layer (e.g., a flexible layer such as a second glass layer that may be thinner than the support layer). The profile of the membrane layer may be adjusted using one or more actuators (e.g., micro-actuators or other control elements) that may be located (or act on the membrane layer) near the periphery of the membrane layer (e.g., proximate the edge of the membrane layer).

In some examples, the optical layer may include a deformable polymer, such as an elastic, viscoelastic or other resilient polymer. An optical layer may include one or more polymers such as a siloxane polymer (e.g., PDMS, polydimethylsiloxane, or another silicon-containing polymer), an elastomer (e.g., a thermoplastic elastomer), or another deformable polymer. In this context, a deformable polymer may conform to modifications of the surface profile of the variable lens, such as within less than one second, and in some examples within less than 100 ms. In some examples, the optical layer may include a fluid (such as a liquid), a foam, an emulsion, a micellar solution, or other fluid material that may be contained within an enclosure at least partially formed by the first and second layers. In some examples, an optical layer may include a liquid component, such as a high refractive index liquid (e.g., an index matching fluid suitable for use with the glass layers if present). In some examples, a polymer network may extend through a liquid component. The mean refractive index of the composite optical layer material may match one or both of layers located proximate or adjacent the optical layer (e.g., at least one glass layer). In some examples, a high refractive index liquid may include a phthalate such as a dialkyl phthalate (e.g., dimethyl phthalate or diethyl phthalate). High index liquids may include aromatic organic liquids, isotropic phases of liquid crystals, alcohols, and the like (e.g., a phthalate in a liquid mixture with an alcohol such as ethanol or methanol). In some examples, a high refractive index liquid may have a refractive index of at least 1.4 for at least one wavelength of visible light at 20° C.

In some examples, a membrane layer may include at least one of a glass (e.g., a silica glass), a ceramic, a polymer, a semiconductor, an inorganic material (e.g., an oxide), or other material. The membrane layer may be generally transparent, for example, transmitting at least one wavelength of visible light through the membrane with an intensity loss of less than 10%. In some examples, a membrane may have an appreciable color tint. The color tint may be compensated by adjusting the color balance of the image displayed to a user.

In some examples, a support layer may include at least one of a glass (e.g., a silica glass), a ceramic, a polymer, a semiconductor, an inorganic material (e.g., an oxide), or other material. The support layer and membrane layer may have similar compositions. In some examples, two support layers of similar thickness may be used (e.g., for a tilt adjustment variable lens). In some examples, a membrane layer may have a thickness that is 50% or less than the thickness of a support layer.

In some examples, one or more transducers (e.g., piezoelectric transducers) may be used to apply a force to the membrane layer, for example, urging the periphery of the membrane layer towards the support layer or pulling the periphery of the membrane layer away from the support layer. In some examples, transducers may be arranged around the periphery of the membrane layer. In some examples, transducers may be used to induce a concave, planar, or convex surface in the membrane layer. For example, the lens assembly may include one or more fixed-focus lenses having a particular optical power, and the optical power of the lens assembly may be adjusted using one or more variable lenses. In some examples, electrostatic attraction (or electrostatic repulsion) between electrodes may be used adjust the membrane profile, where the membrane profile may include curvature and/or tilt components.

In some examples, the membrane surface (upper surface as illustrated) may be tilted relative to the support layer, which may also be referred to as a substrate. The support layer may be normal to the optical axis of the optical assembly. The tilted membrane surface may refract rays passing through the optical assembly, may modify the focal length of the optical assembly, and in some examples may be used to provide astigmatism corrections, provide prism lenses, or provide other optical parameter adjustment(s). In some examples, an actuator on one side of the membrane layer may urge the membrane layer towards or away from the support layer. An actuator on an opposite side of the membrane layer may be unactuated or urge the membrane layer in an opposite direction.

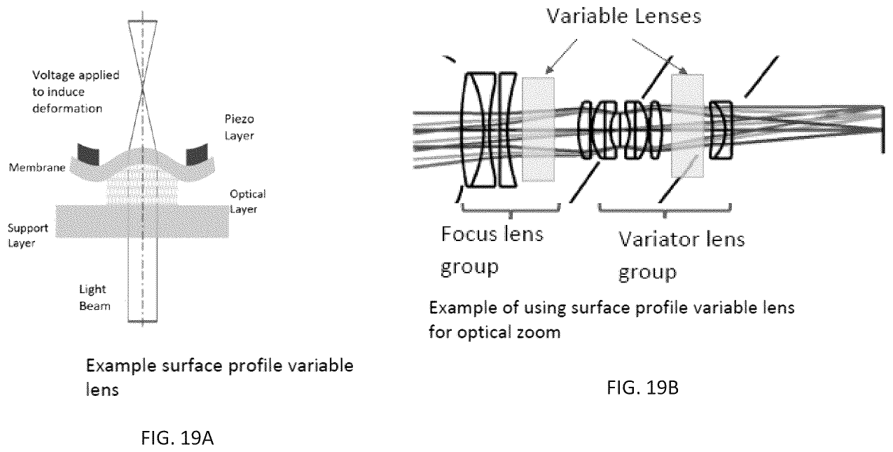

FIGS. 19A and 19B show example optical assemblies including a surface profile variable lens (or “variable lens”) that may be used for optical zoom applications. The lens assembly includes a focus lens group including a first variable lens that may be configured to adjust the focus of the lens assembly. The lens assembly further includes a variator (zoom) lens group that may be used to adjust the zoom (e.g., the field of view) of the lens assembly. The variable lenses may have similar or different configurations.

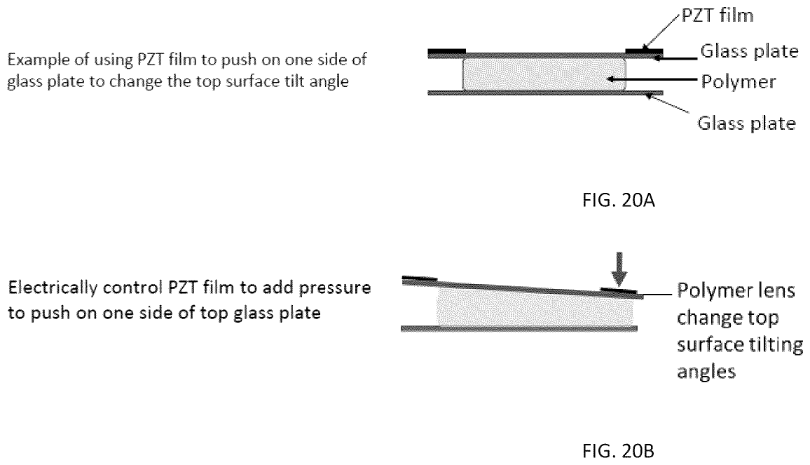

FIGS. 20A and 20B illustrate use of an actuator, for example, a piezoelectric actuator (such as a PZT or lead zirconate titanate film), to push (or pull) on one side of a first layer (e.g., a glass plate) to change the surface tilt angle of a variable lens. Any type of actuator may be used such as a piezoelectric actuator or other actuator. In some examples, a second actuator may be used to control a second side of the first layer, for example, to tilt the first layer in the opposite direction. In some examples, a plurality of actuators may be located around the first layer and used to obtain a desired tilt angle in a desired tilt direction. A tilt angle may be in the range of 0.1-10 degrees. The tilt direction may be along a direction between any two groupings of actuators, such as a pair of actuators. In some examples, an actuator may include one or more piezoelectric layers, such as inorganic piezoelectric layers or polymer piezoelectric layers. In some examples, an actuator may include one or more electroactive polymer layers.

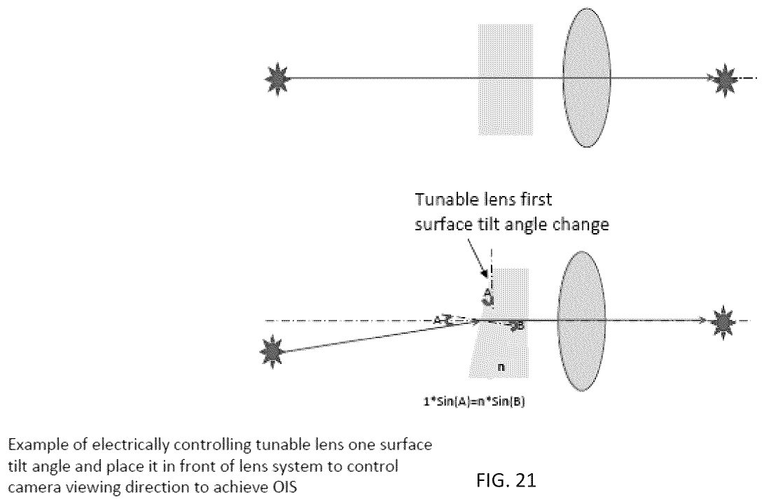

FIG. 21 shows examples of electrically controlling a surface tilt angle of a variable lens. The variable lens may be placed in the optical path of a lens assembly to control the camera viewing direction. This may be used to provide OIS (optical image stabilization). A first surface of a variable lens may have an adjustable tilt angle relative to the optical axis of the lens assembly (indicated by a dashed line).

The light deflection may be determined using Snell's Law (n₁sinθ₁=n₂sinθ₂) where θ₁ is the angle of incidence in a first medium and θ₂ is the angle of refraction in a second medium. For example, the first medium may be air so that n₁=1. The second medium may effectively be the optical layer (e.g., if the first and second layers each have parallel surfaces and do not contribute to light redirection). In some examples, the refractive index of the second medium (e.g., the optical layer of a variable lens) may be at least 1.4 for at least one wavelength of visible light at 20° C. FIG. 21 also shows that the angle of incidence (denoted A, relative to the surface normal) is equal to the tilt angle of the surface of the optical layer. The deflection may be adjusted by adjusting the tilt of a layer (e.g., a support layer or membrane layer) of the variable lens.

In some examples, a device may include one or more accelerometers that may provide accelerometer signals to a controller. The accelerometer signals may provide motion data related to a motion of the device. The controller may provide a suitable control signal to the variable lens to compensate for the motion of the device. The control signal may adjust the orientation and/or surface profile of the membrane layer.

Examples include systems and methods for making and using AR/VR device cameras that may include one or more variable lenses. An AR/VR device camera may include one or more variable lenses (e.g., one or more varifocal lenses) configured to allow the device to perform such operations as image capture, which may further include one or more operations such as zooming, auto-focusing and optical image stabilization. The surface profile variable lens or lenses may be operated, for example, by applying electrical signals to surface profile variable lenses including at least one surface that has a variable profile. In some examples, a variable profile surface may include a membrane, such as a glass membrane. A membrane may have a thickness less than 1 mm, such as a thickness in the range 25 microns-1 mm, such as in the range 50 microns-500 microns.

In some examples, the adjustable surface may be generally rigid, and may have a thickness between 500 microns and 2 mm. A generally rigid adjustable surface may allow tilt adjustments (e.g., for image stabilization) but may allow less focal length adjustment than a more flexible membrane.

Example methods may include computer-implemented methods for operating or fabricating an apparatus, such as an apparatus as described herein. The steps of an example method, such as providing a control signal to a variable lens, may be performed by any suitable computer-executable code and/or computing system. In some examples, one or more of the steps of an example method may represent an algorithm whose structure includes and/or may be represented by multiple sub-steps. In some examples, a method for operating an optical device such as an AR/VR device may include control of a variable lens, for example, to modify focal length, zoom, and/or optical stabilization.

In some examples, an apparatus may include at least one physical processor and physical memory including computer-executable instructions that, when executed by the physical processor, cause the physical processor to control an apparatus or component therein, for example, using a method such as described herein.

In some examples, a non-transitory computer-readable medium may include one or more computer-executable instructions that, when executed by at least one processor of a device, cause the device to adjust at least one optical parameter of a lens assembly, for example, at least one of focal length, zoom, and/or image direction adjustments related to optical stabilization.

Examples may include variable lenses for use in augmented reality devices that allow auto-focused images of the environment to be captured. An example variable lens may include a polymer layer located between a pair of layers, which may be referred to as substrate layers, such as glass plates. One layer may include a membrane layer, such as a glass membrane. In this context, a membrane may have an adjustable profile that allows a discernable adjustment of an optical parameter, such as an optical power change of at least 0.1 diopter. In some examples, a layer (e.g., a membrane layer or other layer) may have an adjustable tilt, for example, a tilt that may provide at least a 3 degree deviation in a light beam direction. A piezoelectric film located on the outer surface of a membrane layer (e.g., a thin glass plate) may allow the membrane layer to be tilted and/or otherwise modified (e.g., curved) to adjust the optical properties of the variable lens. A variable lens may be included in a lens assembly and used to adjust the optical properties of the lens assembly. Applications include focal length adjustment, zoom adjustment and optical stabilization.

Examples include an apparatus (e.g., a system or device) including a camera including a variable lens as described herein (e.g., an augmented reality (AR) or virtual reality (VR) system, where an AR system may include a mixed reality (MR) system). In some examples, a camera may be used for tracking a body part of a user, such as hand-tracking or eye-tracking. Example systems may also include one or more surface profile variable lenses (e.g., varifocal lenses). Surface profile variable lenses may be configured to capture images (e.g., including zoom, auto-focus, and optical image stabilization functions). In some examples, a device controller may apply electrical signals to at least one variable lens in order to change the surface profile of the lens.

Examples include variable lenses for use in augmented reality devices that allow auto-focused images of the environment. A variable lens may include a polymer layer located between a pair of substrates such as glass plates. A piezoelectric film located on a layer may allow tilt adjustment and/or curvature adjustment of the layer to adjust the optical properties of the variable lens and the optical properties of any lens assembly including the variable lens. Applications include focal length adjustment, zoom adjustment and/or optical stabilization, for example, of a camera configured to provide an external image (e.g., of the device environment and objects therein) to the device. The device may then provide a combination of the external image and augmented reality image elements to a user when the user wears the device.

### Anatomical EMG Test Design

Electromyography (EMG) is a technique used to record the electrical activity of muscles and is commonly used for medical and scientific research, as well as for athletic and gaming applications. In recent years, portable and wearable devices such as EMG wristbands have been developed to monitor muscle activity, fatigue, and rehabilitation progress. However, there are some disadvantages to this technology, including cost, accuracy, potential interference, discomfort, and limited applications. Currently, EMG wristbands can be relatively expensive, and the accuracy of the readings can be affected by various factors such as skin impedance, muscle tension, and electrode placement. Additionally, the technology is still in its early stages of development and has room for improvement in terms of accuracy, cost, and versatility of use.

The present disclosure is generally directed to systems and methods for accurately measuring EMG signals in a curved, wrist-worn device that is shaped to replicate the anatomical shape of a user's wrist. Existing attempts to measure EMG signals on wrist-worn devices can be inaccurate since EMG electrode contact pressure is a direct measure of contact quality and the amount of pressure applied to each EMG electrode on an EMG device varies from user to user due to anatomical variations in users' wrists. To account for this variation and ensure accurate signal measurement, this disclosure proposes utilizing individually addressable electrodes that can be individually calibrated to account for anatomical variations in users' wrists and, as a result, the varied amounts of pressure that will be applied to each electrode when the EMG device is worn by a unique user. By doing so, the disclosed systems and methods may improve the reliability and accuracy of EMG signal measurement and analysis in associated devices.

Features from any of the embodiments described herein may be used in combination with one another in accordance with the general principles described herein. These and other embodiments, features, and advantages will be more fully understood upon reading the following detailed description in conjunction with the accompanying drawings and claims.

The following will provide detailed descriptions of systems and methods for accurately measuring EMG signals in an EMG wristband configured to adapt to follow the anatomical wrist shape of a user.

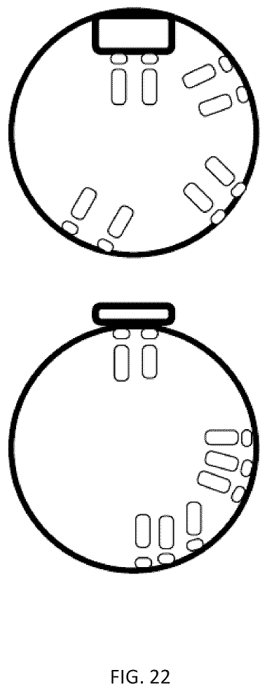

FIG. 22 is an illustration of two perspective views of a wearable device configured for accurately measuring EMG signals. In one example, the wearable device may include individual actuators configured to be retractable for functional testing purposes. The systems described herein may configure the individual actuators to be attached to flexible bands of the wearable device and/or interface with individually addressable electrodes. In certain embodiments, the systems described herein may configure the electrodes to send signals to a physical processor attached to the wearable device.

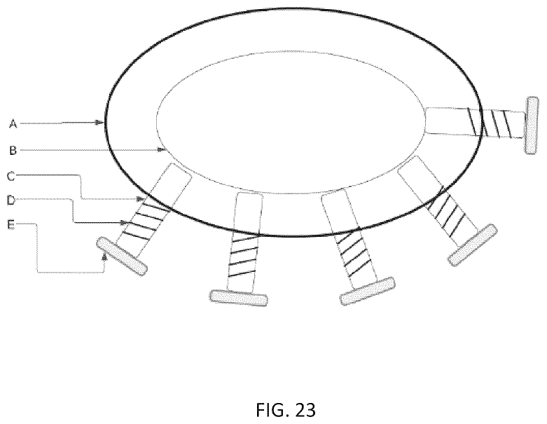

FIG. 23 illustrates a cross sectional view of the wearable device. In some examples, the wearable device may include a frame that is configured to hold electrode plungers. In certain embodiments, the frame may be a solid portion of the wearable device that sets a minimum band size for the user. In other embodiments, a cam may interface with the electrode plungers and dictate the pressure applied to the wearable device. The cam may be set on an actuator that may press the cam into a testing fixture which may push the electrode plungers outward. In one embodiment, the cam may be tapered. According to certain embodiments, the electrode plungers may hold the electrical interface between a testing fixture and the electrodes. The electrode plungers may be aligned on the frame and may be configured to slide in and out of the frame. The electrode plungers may be spring loaded inward, which may enable the electrode plunger plungers to interface with the cam. In one embodiment, each electrode pair may be controlled by at least one electrode plunger. A spring may be attached to each electrode plunger such that each spring can be in a state of tension or compression. In some examples, each spring may enable a connection between an electrode plunger and the frame that may keep each plunger engaged with the cam.

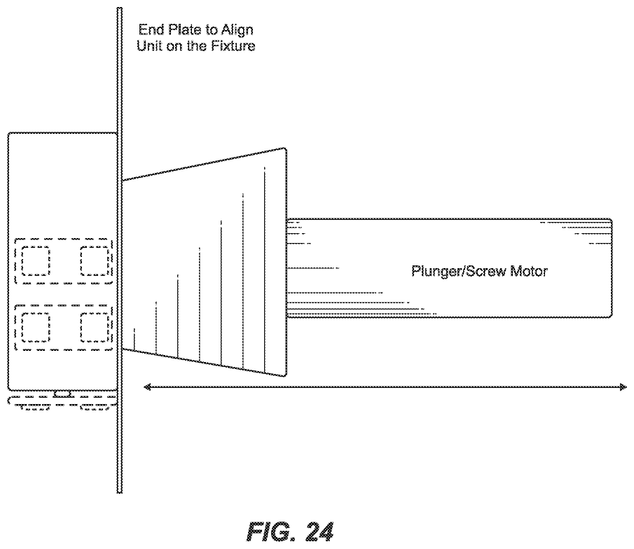

FIG. 24 illustrates a side view of an electrode plunger configured to the wearable device. In one example, the electrode plunger may interface with an endplate that may be used to align the wearable device onto a testing fixture. According to certain embodiments, an operator may position the wearable device on the testing fixture, aligning the electrodes on the wearable device with electrodes positioned onto the testing fixture to secure a connection.

In some examples, the operator starting the test may prompt the cam to move until the desired set pressure is achieved. In this embodiment, all electrodes may be engaged with the device. In some examples, the systems described herein may then send signals through the printed circuit board interface and report out through a testing device.

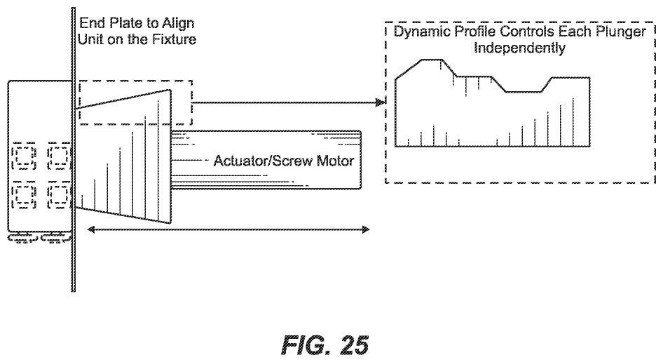

FIG. 25 illustrates a side view of an electrode plunger communicatively coupled to a dynamic profile. In one embodiment, the dynamic profile may control each electrode plunger independently.

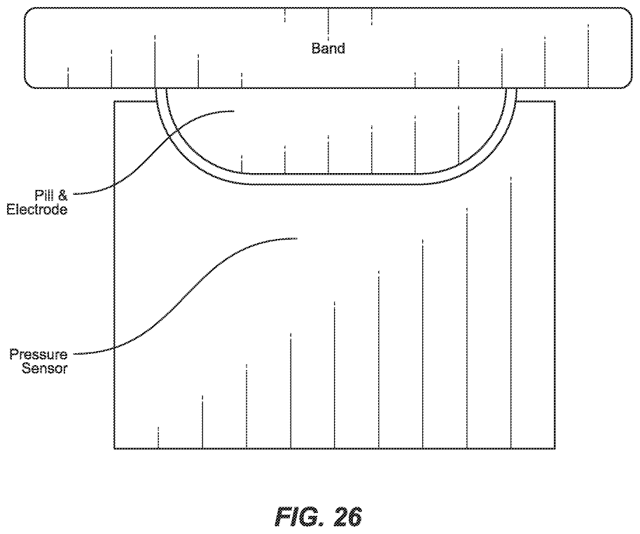

FIG. 26 illustrates a side view of a wearable device configured with complementary parts. In some embodiments, each electrode that may be positioned on each band of the wearable device may be encompassed by a housing unit. According to certain embodiments, the housing unit may interface with a pressure sensor.

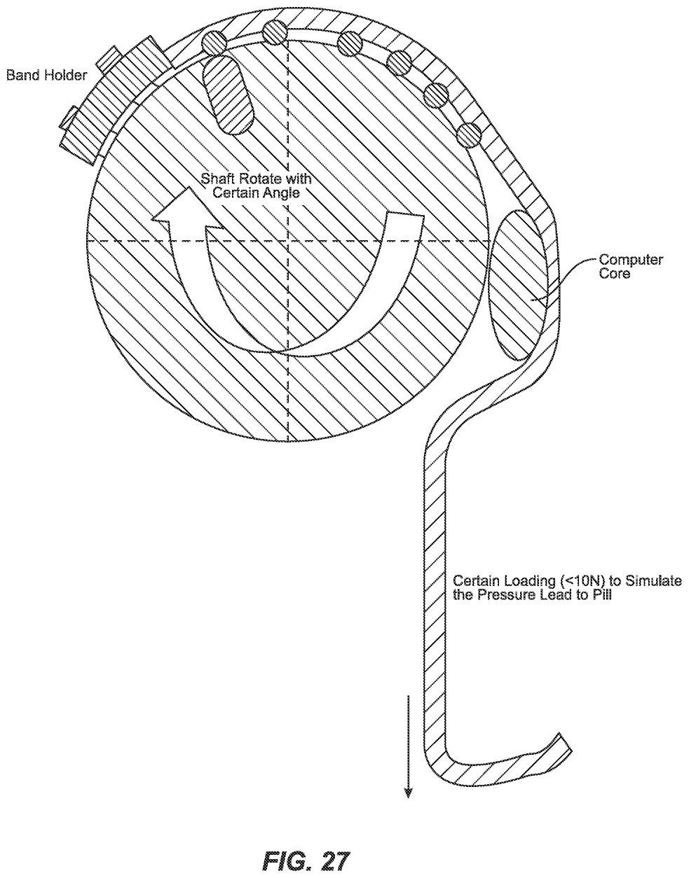

FIG. 27 illustrates a perspective view of a validation fixture that may be configured for functional testing the wearable device. For example, the wearable device may be securely fastened by a clamp connected to a radially extended rotating shaft. The shaft may rotate at a specified angle to apply pressure to the electrodes that may be aligned on the band of the wearable device. According to certain embodiments, a load may be applied to one end of the wearable device band to stimulate the electrodes that may be aligned on the band. The electrodes may be individually addressable and may send signals to a physical processor in response to the pressure applied via the validation fixture.

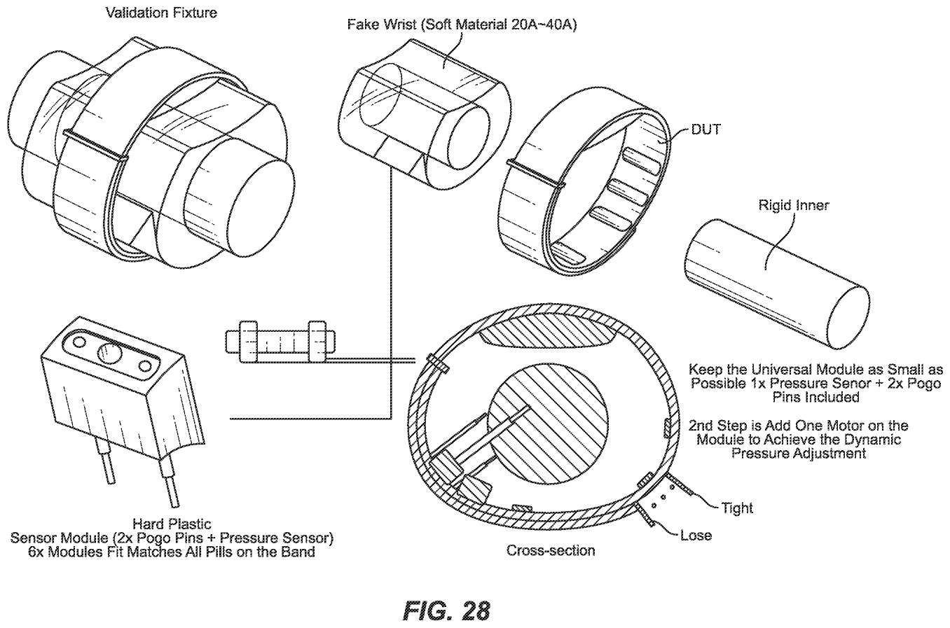

FIG. 28 illustrates a perspective view of a fixed load validation fixture and its complimentary parts. The fixed load validation fixture may include a rigid inner substrate that fits within an aperture of a fixed wrist profile. According to certain embodiments, the wearable device may be positioned around the outer surface of the fixed wrist profile. The fixed load validation fixture may include sensor modules that can connect to each housing unit on the band of the wearable device. The sensor module may include a pressure sensor and pin connectors where each pin connector may be operable to connect to each housing unit.

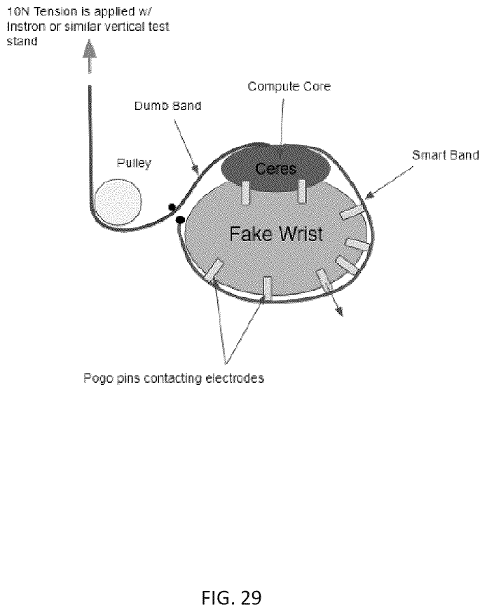

FIG. 29 illustrates a cross sectional view of a fixed load validation fixture configured for functional testing the wearable device. In one example, a fixed load may be applied around a fixed wrist profile during active functional testing of the wearable device. The wearable device may include two bands on opposing sides of the physical processor. According to certain embodiments, at least one of the bands may interface with a pulley to apply tension to the wearable device.

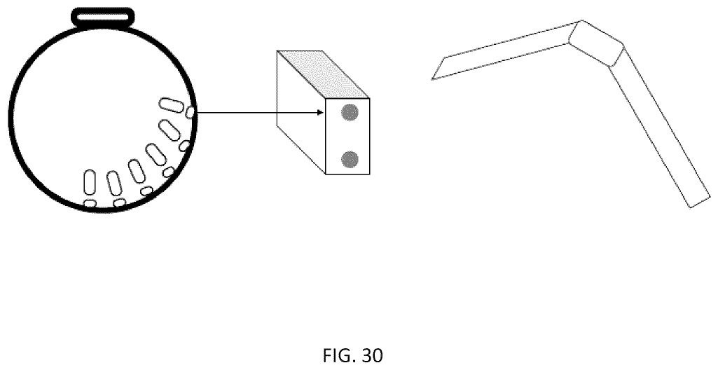

FIG. 30 illustrates a perspective view of a fixed load validation fixture configured with complementary parts. For example, the wearable device may include bands that are variably adjustable in size.

### ReRAM—Based Deep Neural Network Accelerator for Mobile AR/VR Devices

### I. Introduction

Augmented Reality (AR) and Virtual Reality (VR) are the essential techniques for building the metaverse, in which people could live, work, connect and collaborate. However, because AR/VR generates synthetic images/videos as outputs, deep neural networks (DNNs) used for AR/VR are typically closely coupled with the computer graphics pipeline (CGP). DNN accelerators may be based on various technologies (e.g., systolic array, compute-in-memory, emerging non-volatile memory, etc.) to improve the computing speed and energy efficiency. This work considers the complex interaction between the DNNs and the CGP in AR/VR.

A ReARVR is disclosed—a ReRAM-based AR/VR accelerator that implements both the DNNs and the CGP on the same chip. The operators of the CGP are mapped onto ReRAM's crossbar structure, to exploit the same compute-in-memory architecture used for DNN acceleration. Two new mapping schemes are proposed to extend the crossbar structure for cross-product and texture sampling. As the crossbar structure, in some instances, may not support divide operations, a look-up table based approximation may be implemented to replace all the divide operations in the CGP. By supporting each basic CGP operator, ReARVR is capable of running programmable CGPs in which each stage has an arbitrary combination of the basic operators. This may be demonstrated by implementing Pixel Codec Avatar, the state-of-the-art 3D avatar animation in AR/VR, onto the ReARVR. With the design considerations detailed in this work, it is shown that the ReARVR achieves 6.5× speedup and 49% energy reduction compared to a baseline mobile accelerator+GPU design.

The metaverse is considered the next generation of social media. Augmented Reality (AR) and Virtual Reality (VR) are at the center of the existing mediums to build the metaverse. Deep Neural Networks (DNNs) are one of the fundamental building blocks of AR/VR techniques, and are computation and data-hungry algorithms. At the current stage, the metaverse is mainly realized via head-mounted devices such as headsets or smart glasses. The limited energy budget and computation resources on such devices, however, pose a great challenge to DNN based AR/VR applications to generate smooth video outputs with high quality in real-time.

The energy consumption and compute limitation challenges have prompted us to consider plenty of designs to explore domain-specific accelerators with various architectures and technologies, including but not limited to CMOS-based systolic array architectures, NOC-based accelerator designs, near memory computing, and computing inside the memory (CIM). Among them, CIM designs using emerging non-volatile memories (such as STTRAM, and ReRAM) feature low computing power, less data movement, and high computing parallelism. More specifically, ReRAM's crossbar structure can not only store DNN weights but also perform matrix-vector multiplications (MVM) in-situ in an analog manner. Owing to the low-power nature of analog computation, ReRAM-based DNN accelerators can achieve orders of magnitude higher computation efficiency compared with state-of-the-art CMOS designs.

TABLE I
CLASSIFICATION OF AR/VR WITH DNN AND CGP

| Type | Compute Pattern |
|---|---|
| 1 | DNN → CGP |
| 2 | CGP → DNN |
| 3 | DNN → CGP → DNN |

Unlike conventional DNN applications, AR/VR has unique characteristics. Because AR/VR generates synthetic images or videos, the conventional computer graphics pipeline (CGP) is often closely coupled with the DNNs. Based on the interactions between the DNNs and the CGP, these works can be classified into three types, as shown in Table I. In Type 1, the DNN outputs a geometry mesh and a texture, which are fed into the CGP to generate the final RGB value for each screen pixel. In Type 2, the CGP is directly followed by the DNN, i.e., the outputs from the CGP are not the final RGB values, instead, they are used as input features to the DNN to generate the screen pixels. Type 3 is a combination of the former two, where the CGP lies in between two DNNs. In head-mounted devices, the CGP usually runs on mobile GPUs which, unlike their counterparts on desktops or servers, cannot efficiently execute complex DNNs. Therefore, data may need to be constantly moved between the GPU and the accelerator to generate the output image or video.

To combat the above challenge, a ReRAM-based accelerator called ReARVR is disclosed, which is capable of accelerating both the DNNs and the CGP on the same chip for AR/VR applications. ReRAM may have the potential to perform MVM operations for DNNs. However, it is non-trivial to make designs also support the CGP which involves many other operations besides MVM, such as divide operations, cross-product, texture sampling, and element-wise operations. ReARVR explores different ReRAM crossbar-based CIM paradigms for these operations. Disclosed is a look-up table (LUT) based approximation to circumvent the expensive divide operations, with reasonable division approximation errors that do not impact the overall accuracy. To support element-wise operations, the multiplication and subtraction is decomposed into gate-level operations and compute them using the NOR-capable ReRAM crossbar designs. Also disclosed are new crossbar mapping schemes for cross-product and texture sampling.

Disclosed are different CIM paradigms using ReRAM's crossbar structure to support various CGP operators. The entire CGP is implemented in the manner of in situ computing, achieving performance improvements and energy savings compared to the conventional scheme which runs the CGP on GPU or CPU. ReARVR runs the CGP and the DNNs on the same chip and thus avoids frequent massive data movement on the computation boundaries of the CGP and the DNNs. Experiments evaluate real AR/VR applications, which contain state-of-the-art DNN architectures and programmable CGPs, showing an improvement of 6.5× computation speedup and 49% energy reduction compared to a mobile accelerator+GPU architecture baseline.

### II. Background

### A. ReRAM Compute Engine

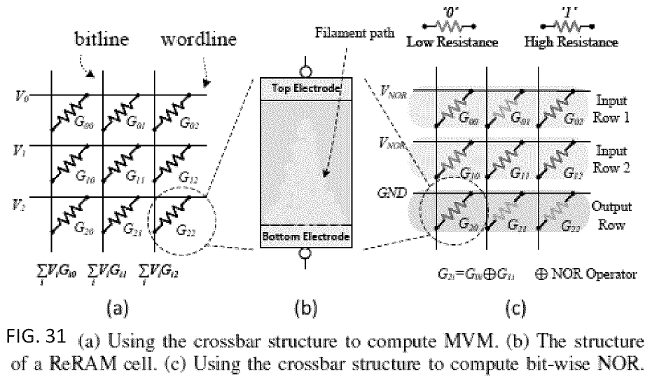

FIG. 31B shows the structure of a ReRAM cell. When appropriate voltages are applied across the top and bottom electrodes, a tunnel of conductive filaments can be constructed/destructed, which changes the cell's resistance. Usually, the ReRAM cell stores a 1 when it is in the high resistance stage, otherwise it stores a 0. If a more complex write circuit is used to program the cell's resistance in a finer granularity, the cell's resistance range can be divided into multiple levels to store more than one bit, thus further improving ReRAM's density. However, storing multiple bits in a cell degrades the precision of the represented value. Therefore, most designs use single bit cells or 2-bit cells to preserve an acceptable precision.

Besides being used as storage, ReRAM can also perform computations. FIG. 31A shows the ReRAM cells organized in a crossbar structure. The horizontal lines are called wordlines, and the vertical lines are called bitlines. A ReRAM cell sits at each cross point of the wordlines and bitlines. This structure is a perfect fit for matrix-vector multiplication (MVM), which is the major operation in DNNs. The input vector is converted into voltages applied on the wordlines, while the weight matrix elements are programmed as the conductance (reciprocal of the resistance) of the ReRAM cells. As a result, the current flowing out from the bitlines convey the product of the input vector and each column of the weight matrix.

FIG. 31C shows another ReRAM CIM scheme that computes bit-wise NOR operations. Two of the rows in the crossbar store the input bits, and an execution voltage VNOR is applied to their wordlines. The third row with GND applied on its wordline will have the bit-wise NOR computation output for each column. Initially, all the cells in the output row are in the low resistance stage (logic ‘0’). If any of the two input cells on the same column are in the low resistance state (logic ‘0’), there will be at least a VNOR voltage (which is above the switching threshold) across the output cell on the same column, thus switching the output cell to the high resistance stage (logic ‘1’). Because NOR is logically complete, it can be used to compute arbitrary logic operations.

### B. Computer Graphics Pipeline

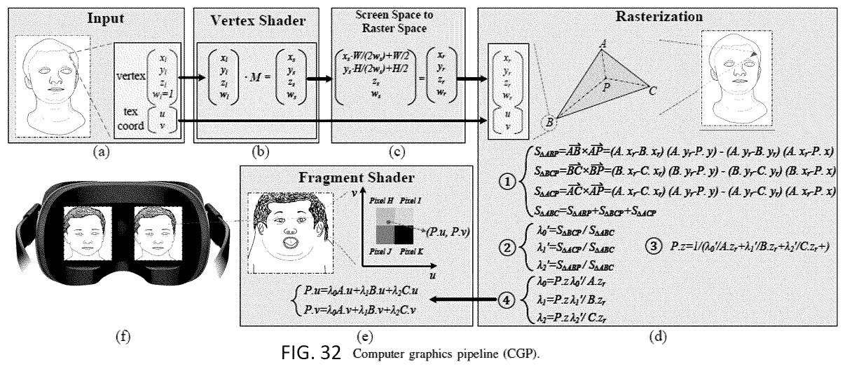

FIG. 32 shows an example of rendering a 3D head using the most basic computer graphics pipeline (CGP). The CGP takes a 3D mesh as input to the vertex shader (FIG. 32B). The 3D mesh is a collection of all the vertices defining the shape of the head. As shown in FIG. 32A, each vertex contains its position in this model's local space ((xl, yl, zl, wl=1)^{T}) and its 2D coordinates within the unwrapped texture image ((u, v)^{T}). The vertex shader computes on each vertex by multiplying it with a matrix (M) to transform it from local space to screen space ((xₛ, yₛ, zₛ,wₛ)^{T}). Then, as shown in FIG. 32C, each vertex's screen space position is transformed to raster space, where W and H are the width and height of the screen. The raster space represents each vertex's location projected onto the screen. Although the screen is a 2D plane, each vertex's depth information (i.e., zᵣ) may be retained in raster space to record its distance to the screen. The majority of the computation is in the rasterization step, which takes all the triangles in the 3D mesh as input.

In FIG. 32D, one triangle ΔABC is taken as an example. Note that the positions of A, B and C have already been transformed into raster space, representing their locations projected on the screen. Given a pixel P on the screen, ΔABC can be divided into three sub-triangles (ΔABP, ΔBCP, and ΔACP). Step \textcircled{1} computes the areas of these three sub-triangles. This step can also detect whether P is outside ΔABC by checking if any of the computed areas is negative. If P is indeed inside ΔABC, continue to step \textcircled{2} to calculate the ratio of each sub-triangle's area to ΔABC's area. Step \textcircled{3} interpolates P's depth from A, B and C. Then, P's barycentric coordinates ((λ0, λ1, λ2)^{T}) may be obtained from step \textcircled{4} . Barycentric coordinates represent P's relative position within ΔABC. After rasterization, each pixel's barycentric coordinates may be obtained within its containing triangle.

Finally, the fragment shader (FIG. 32E) determines each screen pixel's RGB value. For example, the screen pixel P's u and v are interpolated from the triangle's three vertices using its barycentric coordinates. Then, P's RGB value is bilinearly sampled from the four nearest texture pixels.

FIG. 32 only shows the most basic operations in the CGP. It is also possible for the programmer to replace certain stages in the pipeline with their own programs, e.g., custom computations in the vertex shader and the fragment shader.

### III. Design Details

An overview of the proposed ReARVR accelerator is provided in Sec. III-A. Details of mapping each step in FIG. 32 onto ReRAM crossbars is disclosed from Sec. III-B to Sec. III-E. In Sec. III-F, the entire PICA decoder implementation is mapped onto ReARVR to showcase the ReARVR's ability to support complex real-world AR/VR applications.

### A. Architecture Overview

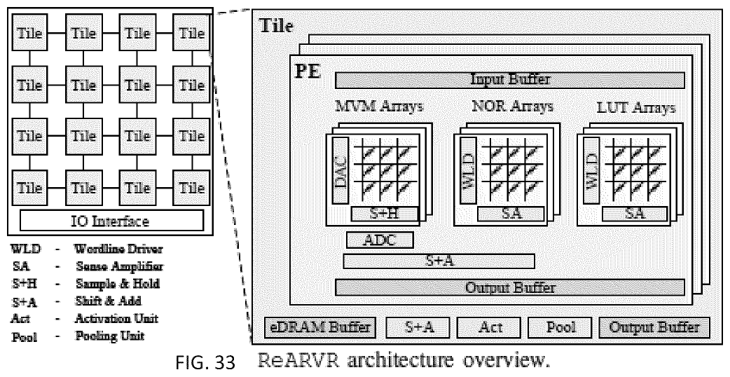

The overview of ReARVR's architecture is shown in FIG. 33. ReARVR is a tiled structure that uses a concentrated mesh to communicate between the tiles. Each tile has an eDRAM buffer to store the input to the DNNs or the CGP. All or some of the CGP operations and DNN's MVM operations are taken place inside the processing elements (PEs). The crossbars in each PE are partitioned into three regions: the MVM arrays, the NOR arrays, and the LUT arrays. The MVM arrays are similar to comparative ReRAM-based DNN designs. The input vector is converted to analog voltage values through digital-to-analog converters (DACs). After the MVM operation in the crossbars, each column's current is first latched in the sample-and-hold unit (S+H), then converted back to digital values by analog-to-digital converters (ADCs). Using single-bit cells in the crossbars, a full value (e.g., 8-bit fixed point) may need to be split across multiple columns. Therefore, a shift-and-add unit (S+A) may be implemented to reassemble the bits from the ADCs. The results from different PEs are summed up in the tile's S+A. The tile also has an activation unit (Act) for activation functions and a pooling unit (Pool) for pooling layers in the DNNs. The NOR arrays are responsible for the cross-product and elementwise operations in the CGP. Since each basic multiplication or subtraction is broken down into NOR operations performed on the same column, the bits of the result are also scattered on the same column. Therefore, the result bits may be sequentially read out and reassembled using the same S+A shared with the MVM arrays. The LUT arrays are used to replace the CGP's divide operations with a proposed approximate solution (Sec. III-C).

### B. Vertex Shader

As shown in FIG. 32B, the vertex shader multiplies a 4×4 matrix (M) with all the vertices ((xl, yl, zl, wl)^{T}) in the model, which is identical to MVM operations in DNNs. Therefore, it is straightforward to implement the vertex shader in ReARVR's MVM arrays. Because all vertices compute with the same M, the vertices may be stored inside the crossbar, while using the row vectors of M as input. One row of M may be used as input to the MVM arrays in each cycle, therefore, the vertex shader may only need four cycles to complete the MVM. Because each vertex vector may only have four elements, for each MVM computation it may be required to activate four rows of the crossbar simultaneously. It has been identified in comparative works that it could be impractical to activate the entire crossbar in a single cycle, otherwise, the computation accuracy may be affected due to per-cell current deviation. In addition, ADC takes more than 80% of the total power in ReRAM-based DNN accelerator designs, and ADC's power increases exponentially with its resolution. Therefore, considering other MVM operations in ReARVR (i.e., rasterization in Sec. III-D and texture sampling in Sec. III-E), in this example, the maximum number of rows that can be simultaneously activated may be set to be six, thus the ADC's resolution can be reduced to 4 bits. Accordingly, for DNN's MVM operations that involve vectors longer than six, the vector may be partitioned into multiple shorter vectors of six elements.

### C. Space Transformation

The equation in FIG. 32C transforms each vertex's position from screen space to raster space. However, it involves divide operations which are hard to implement in both ReRAM and CMOS logic. Exponential and logarithm operations are used to circumvent the divide operations. Specifically, the equation can be rewritten in the following format:

$$\{ \begin{matrix}\frac{{x}_{s}}{{w}_{s}} = \frac{{e}^{{logx}_{s}}}{{e}^{{logw}_{s}}} = {e}^{{logx}_{s} - {logw}_{s}} \\ \frac{{y}_{s}}{{w}_{s}} = \frac{{e}^{{logy}_{s}}}{{e}^{{logw}_{s}}} = {e}^{{logy}_{s} - {logw}_{s}}\end{matrix} \qquad ( 1 )$$

The exponential and logarithm operations can be implemented using look-up tables (LUTs). Therefore, each divide operation is replaced by three LUT operations and one subtraction. After xₛ, yₛ, and wₛ are computed in the vertex shader, they are used as the index to access the LUT arrays to look up their logarithms. Then, the NOR arrays are used to compute the subtraction in a bit-wise manner by breaking down the subtraction into NOR operations. The results of the subtraction are used as the index to access the LUT arrays again to look up their exponentials. Finally, as W and H are fixed constants determined by the screen size, the S+A can be used to multiply and add W/2 and H/2. If the screen width (or height) is not a power of 2, W (or H) is set to the smallest power of 2 that is larger than the screen width (or height).

After the space transformation, if two vertices are in the same triangle, the NOR arrays are used to compute the product of their xᵣ and yᵣ. For example, if vertex A and B are two vertices in the same triangle, A·xᵣ B·yᵣ and A·yᵣB·xᵣ may be computed. These two values will be used in the rasterization step (see Sec. III-D).

### D. Rasterization

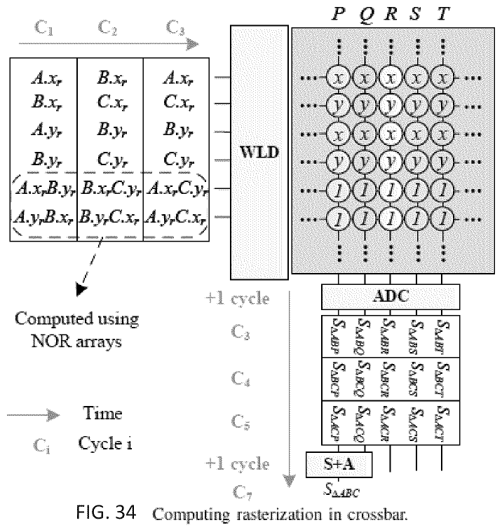

Rasterization computes each screen pixel's barycentric coordinates within the triangle that overlaps with the pixel on screen. The MVM arrays are used to compute the areas of the sub-triangles (\textcircled{1} in FIG. 32D). Six consecutive rows on the same column are used for each pixel. FIG. 34 shows an example that computes the sub-areas of ΔABC split by pixels P, Q, R, etc. In the first cycle, the xᵣ and yᵣ of A and B, together with their products (computed in space transformation in Sec. III-C) are fed into the crossbar to compute the first equation in \textcircled{1} of FIG. 32D. Similarly, the second and third cycles compute the other two sub-areas. As mentioned in Sec. II-B, the signs of the computed sub-areas will be used to determine which pixel is actually inside the triangle (not shown in the figure). After 3 cycles, the three sub-areas will be summed up to get the full triangle's total area within the S+A (P is the pixel that is actually inside ΔABC in the example).

Steps \textcircled{2}-\textcircled{4} also have divide operations. The LUT method may be used to replace the divide operation with exponentials and logarithms. The divide operations of \textcircled{2} and \textcircled{3} can be combined. For example, SΔABP/SΔABC and λ′/A·zᵣ may not be computed separately with six LUT operations and two subtractions in total. Instead, three LUT operations may be performed to convert SΔABP, SΔABC and A·zᵣ to their logarithms, followed by two subtractions and one exponential LUT operation, leading to a total of four LUT operations and two subtractions. Note that the logarithm LUT result for SΔABC can be shared between the three equations in \textcircled{2}, and the divide result of λ′/A·zᵣ, λ′/B·zᵣ, and λ′/C·zᵣ can be shared between \textcircled{3} and \textcircled{4}. Therefore, the total number of operations can be further reduced. In summary, the rasterization for one triangle may need 14 LUT and 10 NOR-based subtractions in total.

Because a triangle may only overlap with a small region of pixels on the screen, nearby pixels are placed in the same crossbar. In the above example, P, Q, R, etc. are adjacent pixels on the screen. Therefore, each triangle, in some instances, may not need to compute with every pixel in all the crossbars. For a given triangle, its three vertices' xᵣ and yᵣ may be used to determine the target crossbars that may contain the overlapped screen pixels, similar to the bounding box used in conventional rasterization.

### E. Fragment Shader

The basic fragment shader performs two tasks: (1) computing each pixel's (u, v)^{T} coordinates within the texture, and (2) using the pixel's (u, v)^{T} to bilinearly sample its RGB value from its four nearest texture pixels.

The first task uses the equation in FIG. 32E. Although each triangle's three vertices and their (u, v)^{T} are not changed throughout the pipeline, the vertices compute with different input. Therefore, the NOR crossbars are used for this task.

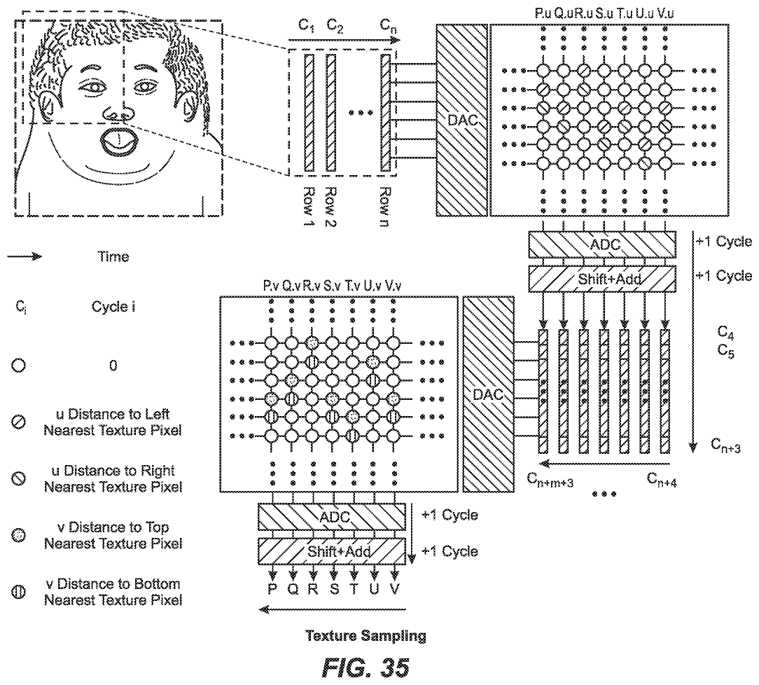

After each screen pixel's (u, v)^{T} are computed, the second task is implemented by mapping them onto MVM crossbars as shown in FIG. 35 to bilinearly sample the screen pixel's RGB values from the four nearest texture pixels. Each screen pixel's u and v are stored in two different crossbars. The top crossbar in FIG. 35 shows an example of storing the us of pixels P, Q, R, etc. Each pixel occupies one column, and only two consecutive cells in the column have non-zero values. The first non-zero cell stores the distance of this screen pixel to the nearest texture pixel on its left (H or J in FIG. 32E), the second non-zero cell stores the distance of this screen pixel to the nearest texture pixel on its right (I or K in FIG. 2(e)). The vs of the screen pixels are stored on the bottom crossbar in FIG. 35 in a similar manner, where the non-zero cells store the screen pixel's distance to the nearest texture pixel on its top (H or I in FIG. 32E) and bottom (J or K in FIG. 32E).

The texture is divided into n×m blocks, and each cycle feeds one row of the block into the first crossbar storing us. After n+3 cycles, the bilinearly sampling along the u direction is done for all the pixels. The next m+3 cycles will bilinearly sample along the v direction.

Finally, a screen pixel's bilinear sampling result will be ready for each cycle. Since the MVM arrays may only activate 6 rows at one time, n=m=6.

Nearby screen pixels are stored on the same crossbar. Because nearby screen pixels (u, v)^{T}s are close to each other, their non-zero cells in the crossbar exhibit strong spatial locality.

### F. Example: PICA

Pixel Codec Avatar (PiCA) is a recent work to render photorealistic avatars in real time on head-mounted devices. PiCA uses a custom programmable CGP which sits in between a base decoder and a pixel decoder (classified as Type 3 in Table I). PiCA is used as a realistic case study to highlight ReARVR's support for complex AR/VR applications.

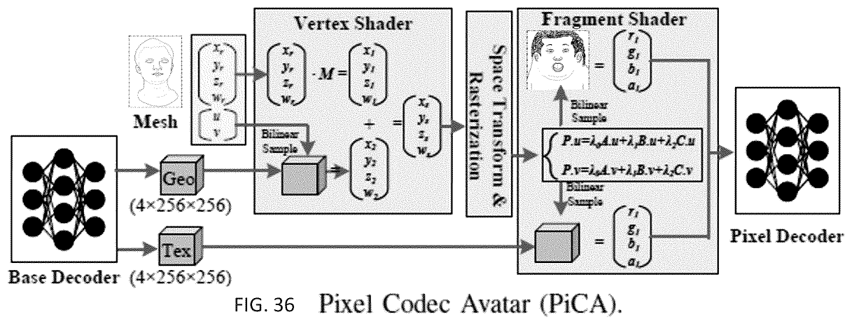

PiCA's workflow is illustrated in FIG. 36. The first DNN (base decoder) outputs a geometry tensor and a texture tensor, whose dimensions are both 4×256×256. Besides multiplying the matrix M, the vertex shader also takes the geometry tensor as input and uses the vertices' (u, v)^{T} to sample the tensor. The sampled result will be added to the MVM results and output to the next stages in the CGP. The fragment shader still first calculates each screen pixel's (u, v)^{T}, which is then used to sample from the input texture as well as the texture tensor from the base decoder. The sampled results are then used as input features to feed into the second DNN (pixel decoder).

PiCA's CGP uses two additional bilinear sampling and element-wise additions. The method proposed in Sec. III-E is used to perform the two new bilinear samplings. Similar to element-wise subtraction, element-wise addition can be broken down into NOR gates to be implemented using the NOR arrays in ReARVR.

### IV. Methodology

TABLE II
REARVR CONFIGURATIONS OF ONE PE

| | | |
|---|---|---|
| Component | Spec | Power |

PE (12 PEs per tile)

| | | | |
|---|---|---|---|
| MVM crossbar | number: 4; size: 128 × 128 | 1.72 | mW |
| NOR crossbar | number: 4; size: 128 × 128 | 0.07 | mW |
| LUT crossbar | number: 1; size: 128 × 128 | 1.71 | mW |
| DAC | number: 4 × 128; resolution: 1 bit | 2 | mW |
| S + H | number: 4 × 128 | 5 | μW |
| ADC | number: 4; resolution: 4 bits | 0.9 | mW |
| WLD | number: 5 | 2.2 | mW |
| SA | number: 8 | 7.6 | mW |
| S + A | number: 4 | 0.2 | mW |
| Input buffer | size: 2 KB | 1.24 | mW |
| Output buffer | size: 256 B | 0.23 | mW |

Tile (168 tiles in the chip)

| | | | |
|---|---|---|---|
| eDRAM buffer | size: 64 KB; banks: 2 | 20.7 | mW |
| Output buffer | size: 3 KB | 1.68 | mW |
| S + A | number: 1 | 0.05 | mW |
| Act | number: 2 | 0.52 | mW |
| Pool | number: 1 | 0.4 | mW |

The configurations of ReARVR are listed in Table II. An in-house simulator is used to evaluate the performance and energy improvements of ReARVR. ReARVR uses single-bit ReRAM cells for all the three types of arrays. The crossbar parameters are modeled using Nvsim. As ReARVR accesses at most six rows at the same time for MVM crossbars, ADCs with 4-bit resolution may be needed. The ADC power consumption may be evaluated for different resolutions. CACTI is used to estimate the eDRAM and SRAM buffer parameters. Other components' parameters are derived from ISAAC.

As benchmarks, four avatars are generated based on PICA with different CGP configurations listed in Table III. All avatars use the same base decoder and pixel decoder, for which the detailed network architectures are found in.

TABLE III
CONFIGURATIONS OF DIFFERENT AVATARS

| Avatar | Resolution | Num of Vertices |
|---|---|---|
| 1 | 512 × 512 | 30000 |
| 2 | 1024 × 1024 | 5471 |
| 3 | 512 × 512 | 7306 |
| 4 | 1024 × 1024 | 30000 |

ReARVR is compared against a mobile accelerator+GPU setup as the baseline. The widely adopted ISAAC is chosen as the baseline accelerator, and modified the simulator accordingly to simulate ISAAC. The baseline GPU is a Qualcomm Adreno 650. The CGP of the benchmarks is profiled on the real GPU to get the energy numbers and used Attila to emulate the performance.

### V. Experimental Results

### A. Performance

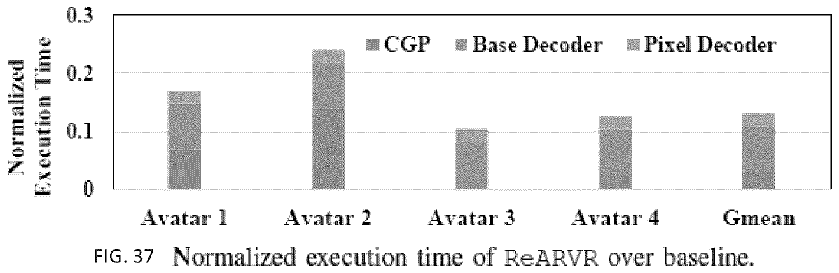

FIG. 37 shows the execution time of running PICA on ReARVR normalized to the ISAAC+GPU baseline. Because different avatars use the same base decoder and pixel decoder, the decoder execution time is kept the same across different avatars. Although each crossbar in ReARVR may only activates six rows at a time and thus ReARVR may need more cycles to compute a MVM than ISAAC, there is still performance saving over ISAAC because (1) reading the single-bit cells in ReARVR is faster than reading the 2-bit cells in ISAAC; (2) activating a small region of the crossbar is faster than activating the entire crossbar. When only comparing the DNN efficiency on ReARVR and ISAAC, ReARVR achieve 4.2× and 2.5× speedup on average for the base decoder and pixel decoder, respectively. ReARVR's CGP speedup over GPU depends on the screen resolution (number of screen pixels) and model size (number of vertices). Since the rasterization and texture sampling may need to program the pixel data onto the crossbars for each frame, the higher resolution slightly lowers the speedup. In the vertex shader the vertices are constant and programmed only once in the crossbars, whereas in the rasterization the vertices are used as input. As a result, the avatars with more vertices show higher speedups. Comparing the execution time of the entire PICA, ReARVR achieves 6.5× speedup on average (Geo-Mean, FIG. 37) over the ISAAC+GPU baseline.

### B. Energy

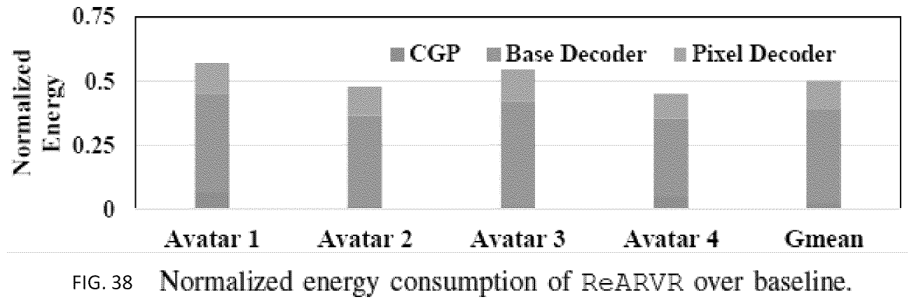

FIG. 38 shows the energy consumption of ReARVR normalized to the ISAAC+GPU baseline. Because of the single-bit FIG. 38. Normalized energy consumption of ReARVR over baseline cells and smaller activated regions in the crossbars, the energy of DNNs on ReARVR is only 55% of ISAAC. ReARVR's CGP energy saving is more sensitive to the model size as shown in FIG. 38. This is because more vertices increase the computation demand on vertex shader and rasterization, which mainly require MVM operations that frequently use ADCs. On average, ReARVR saves 49% energy compared to the ISAAC+GPU baseline (Geo-mean, FIG. 38).

### VI. Conclusion

Disclosed herein is a ReARVR-the first ReRAM-based accelerator that supports both DNN and CGP using CIM. ReARVR not only achieves performance and energy improvements over the baseline accelerator+GPU setup but also allows the programmer to design complex AR/VR algorithms with more coupled interactions between the DNNs and the CGP.

### EXAMPLE EMBODIMENTS

Example 1: An apparatus includes:
(I) multiplexing circuitry comprising a plurality of inputs and at least one output; and a transmission-line termination coupled to at least one of the plurality of inputs, the transmission-line termination matching a predetermined transmission-line impedance, or
(II) multiplexing circuitry comprising a plurality of inputs and at least one output; and a transmission-line termination coupled to the output, the transmission-line termination matching a predetermined transmission-line impedance, or
(III) demultiplexing circuitry comprising a plurality of outputs and at least one input; and a transmission-line termination coupled to at least one of the plurality of outputs, the transmission-line termination matching a predetermined transmission-line impedance, or
(IV) multiplexing circuitry comprising a plurality of outputs and at least one input; and a transmission-line termination coupled to the input, the transmission-line termination matching a predetermined transmission-line impedance, or
(V) a plurality of transmission lines; a plurality of signal-generating circuits, each of the plurality of signal-generating circuits being coupled to one of the plurality of transmission lines; at least one additional transmission line; at least one signal-processing circuit coupled to the additional transmission line; a multiplexer having a plurality of inputs and at least one output; a plurality of matching networks, each of the plurality of matching networks coupling one of the plurality of transmission lines to one of the plurality of inputs of the multiplexer; and an additional matching network coupling the additional transmission line to the output of the multiplexer, or
(VI) a plurality of transmission lines; a plurality of signal-generating circuits, each of the plurality of signal-generating circuits being coupled to one of the plurality of transmission lines; at least one additional transmission line; at least one signal-processing circuit coupled to the additional transmission line; a multiplexer having a plurality of inputs and at least one output; a plurality of matching networks, each of the plurality of matching networks coupling one of the plurality of transmission lines to one of the plurality of inputs of the multiplexer; and an additional matching network coupling the additional transmission line to the output of the multiplexer, or
(VII) a plurality of transmission lines; a plurality of signal-processing circuits, each of the plurality of signal-processing circuits being coupled to one of the plurality of transmission lines; at least one additional transmission line; at least one signal-generating circuit coupled to the additional transmission line; a demultiplexer having a plurality of outputs and at least one input; a plurality of matching networks, each of the plurality of matching networks coupling one of the plurality of transmission lines to one of the plurality of outputs of the demultiplexer; and an additional matching network coupling the additional transmission line to the input of the
(VIII) a camera configured to receive light from the external environment of the device and to provide a camera signal; a controller configured to receive the camera signal and to provide an external image signal based on the camera signal and to provide an augmented reality element signal; and a display configured to show an augmented reality image element based on the augmented reality element signal and an external image based on the external image signal, wherein: the camera includes a variable lens comprising: a first layer; an optical layer; a second layer; and at least one actuator, wherein: the optical layer includes a polymer; the optical layer is located between the first layer and the second layer; and the first layer has a surface profile that is adjustable using the at least one actuator.

Example 2: The apparatus of Example 1, where the transmission-line termination includes a spiral transmission-line matching network.

Example 3: The apparatus of any of Examples 1 and 2, where the apparatus includes artificial-reality glasses.

Example 4: The apparatus of any of Examples 1-3, where the plurality of signal-generating circuits comprise a plurality of simultaneous localization and mapping (SLAM) cameras.

Example 5: The apparatus of Example 1, where the variable lens is configured to provide the camera with at least one of an auto-focus, an optical zoom, or an optical image stabilization function.

Example 6: A method includes identifying a wearable device comprising a frame comprising a plurality of electrodes; calibrating the plurality of electrodes by, for each electrode: loading a spring onto an electrode plunger that interfaces with a cam; applying pressure to the electrode via the cam; measuring a response of the electrode to the pressure; and receiving the response of the electrodes via an electrode interface.

Example 7: The method of Example 6, further comprising setting a minimum size of the wearable device for a user via the frame.

Example 8: The method of any of Examples 6 and 7, where the electrode plunger is configured for sliding into the frame.

Example 9: The method of any of Examples 6-8, where the cam interfaces with an actuator.

Example 10: The method of any of Examples 6-9, where loading the spring comprises configuring the spring in a state of tension.

Example 11: The method of any of Examples 6-10, where loading the spring comprises configuring the spring in a state of compression.

Example 12: The method of any of Examples 6-11, where the electrode plunger controls at least one electrode pair.

Example 13: The method of any of Examples 6-12, further including individually addressing the plurality of electrodes.

Example 14: The method of any of Examples 6-13, where the electrode interface receives the electrode response as a signal.

Example 15: An apparatus includes first one or more resistive random-access memory-crossbar arrays configured to perform matrix-vector multiplication; second one or more resistive random-access memory-crossbar arrays configured to perform cross-product and/or element-wise operations; and third one or more resistive random-access memory-crossbar arrays configured as one or more look-up tables.

Example 16: The apparatus of Example 15, where the first one or more resistive random-access memory-crossbar arrays are configured to perform operations of a deep neural network and a computer graphics pipeline.

Example 17: The apparatus of Example 16, where the first one or more resistive random-access memory-crossbar arrays are configured to perform vertex-shader operations, rasterization operations, and fragment-shader operations.

Example 18: The apparatus of any of Examples 15-17, where the second one or more resistive random-access memory-crossbar arrays are configured to perform cross-product and element-wise operations of a computer graphics pipeline.

Example 19: The apparatus of any of Examples 15-18, where the third one or more resistive random-access memory-crossbar arrays are configured to estimate divide operations of a computer graphics pipeline.

What is claimed is:

1. An apparatus comprising:
multiplexing circuitry comprising a plurality of inputs and at least one output; and
a transmission-line termination coupled to at least one of the plurality of inputs, the transmission-line termination matching a predetermined transmission-line impedance, or multiplexing circuitry comprising a plurality of inputs and at least one output; and
a transmission-line termination coupled to the output, the transmission-line termination matching a predetermined transmission-line impedance, or demultiplexing circuitry comprising a plurality of outputs and at least one input; and
a transmission-line termination coupled to at least one of the plurality of outputs, the transmission-line termination matching a predetermined transmission-line impedance, OR multiplexing circuitry comprising a plurality of outputs and at least one input; and
a transmission-line termination coupled to the input, the transmission-line termination matching a predetermined transmission-line impedance, or a plurality of transmission lines;
a plurality of signal-generating circuits, each of the plurality of signal-generating circuits being coupled to one of the plurality of transmission lines;
at least one additional transmission line;
at least one signal-processing circuit coupled to the additional transmission line;
a multiplexer having a plurality of inputs and at least one output;
a plurality of matching networks, each of the plurality of matching networks coupling one of the plurality of transmission lines to one of the plurality of inputs of the multiplexer; and
an additional matching network coupling the additional transmission line to the output of the multiplexer, or
a plurality of transmission lines;
a plurality of signal-generating circuits, each of the plurality of signal-generating circuits being coupled to one of the plurality of transmission lines;
at least one additional transmission line;
at least one signal-processing circuit coupled to the additional transmission line;
a multiplexer having a plurality of inputs and at least one output;
a plurality of matching networks, each of the plurality of matching networks coupling one of the plurality of transmission lines to one of the plurality of inputs of the multiplexer; and
an additional matching network coupling the additional transmission line to the output of the multiplexer, or
a plurality of transmission lines;
a plurality of signal-processing circuits, each of the plurality of signal-processing circuits being coupled to one of the plurality of transmission lines;
at least one additional transmission line;
at least one signal-generating circuit coupled to the additional transmission line;
a demultiplexer having a plurality of outputs and at least one input;
a plurality of matching networks, each of the plurality of matching networks coupling one of the plurality of transmission lines to one of the plurality of outputs of the demultiplexer; and
an additional matching network coupling the additional transmission line to the input of the demultiplexer, or
a camera configured to receive light from the external environment of the device and to provide a camera signal;
a controller configured to receive the camera signal and to provide an external image signal based on the camera signal and to provide an augmented reality element signal; and
a display configured to show an augmented reality image element based on the augmented reality element signal and an external image based on the external image signal, wherein:
the camera includes a variable lens comprising:
a first layer;
an optical layer;
a second layer; and
at least one actuator,
wherein:
the optical layer includes a polymer;
the optical layer is located between the first layer and the second layer; and
the first layer has a surface profile that is adjustable using the at least one actuator.

2. The apparatus of claim 1, wherein the transmission-line termination comprises a spiral transmission-line matching network.

3. The apparatus of claim 1, wherein the apparatus comprises artificial-reality glasses.

4. The apparatus of claim 1, wherein the plurality of signal-generating circuits comprise a plurality of simultaneous localization and mapping (SLAM) cameras.

5. The apparatus of claim 1, wherein the variable lens is configured to provide the camera with at least one of an auto-focus, an optical zoom, or an optical image stabilization function.

6. A method comprising:
identifying a wearable device comprising a frame comprising a plurality of electrodes;
calibrating the plurality of electrodes by, for each electrode:
loading a spring onto an electrode plunger that interfaces with a cam;
applying pressure to the electrode via the cam;
measuring a response of the electrode to the pressure; and
receiving the response of the electrodes via an electrode interface.

7. The method of claim 6, further comprising setting a minimum size of the wearable device for a user via the frame.

8. The method of claim 6, wherein the electrode plunger is configured for sliding into the frame.

9. The method of claim 6, wherein the cam interfaces with an actuator.

10. The method of claim 6, wherein loading the spring comprises configuring the spring in a state of tension.

11. The method of claim 6, wherein loading the spring comprises configuring the spring in a state of compression.

12. The method of claim 6, wherein the electrode plunger controls at least one electrode pair.

13. The method of claim 6, further comprising individually addressing the plurality of electrodes.

14. The method of claim 6, wherein the electrode interface receives the electrode response as a signal.

15. An apparatus comprising:
first one or more resistive random-access memory-crossbar arrays configured to perform matrix-vector multiplication;
second one or more resistive random-access memory-crossbar arrays configured to perform cross-product and/or element-wise operations; and
third one or more resistive random-access memory-crossbar arrays configured as one or more look-up tables.

16. The apparatus of claim 15, wherein the first one or more resistive random-access memory-crossbar arrays are configured to perform operations of a deep neural network and a computer graphics pipeline.

17. The apparatus of claim 16, wherein the first one or more resistive random-access memory-crossbar arrays are configured to perform vertex-shader operations, rasterization operations, and fragment-shader operations.

18. The apparatus of claim 15, wherein the second one or more resistive random-access memory-crossbar arrays are configured to perform cross-product and element-wise operations of a computer graphics pipeline.

19. The apparatus of claim 15, wherein the third one or more resistive random-access memory-crossbar arrays are configured to estimate divide operations of a computer graphics pipeline.
